(19) United States
(12) Patent Application Publication
(10) Pub. No.: US 2013/0167877 A1
(43) Pub. Date: Jul. 4, 2013

(54) SUBSTRATE PROCESSING APPARATUS AND SUBSTRATE PROCESSING METHOD

(71) Applicant: DAINIPPON SCREEN MFG. CO., LTD., Kyoto-shi (JP)

(72) Inventors: Naozumi FUJIWARA, Kyoto (JP); Katsuhiko MIYA, Kyoto (JP); Masahiko KATO, Kyoto (JP); Kentaro TOKURI, Kyoto (JP)

(73) Assignee: DAINIPPON SCREEN MFG. CO., LTD., Kyoto-shi (JP)

(21) Appl. No.: 13/730,443

(22) Filed: Dec. 28, 2012

(30) Foreign Application Priority Data
Dec. 28, 2011 (JP) 2011-287742
Dec. 28, 2011 (JP) 2011-287743
Dec. 28, 2011 (JP) 2011-287744
Dec. 28, 2011 (JP) 2011-287745

(51) Int. Cl. B08B 3/04

(52) U.S. Cl. CPC B08B 3/04
USPC 134/26; 134/105

(57) ABSTRACT

In a substrate processing apparatus, a liquid film of a supercooled liquid of pure water is formed on the upper surface of a substrate and then cooled with cooling gas into a frozen film. The temperature of the liquid film is lower than the freezing point of pure water, and thus the liquid film is in an easy-to-freeze state. Thus, the time required to freeze the liquid film can be shortened. Even if the temperature of the cooling gas is increased, the liquid film can be speedily frozen as compared with the case in which a liquid film is formed of pure water having a temperature higher than its freezing point. Thus, heat insulating facilities such as piping that supply cooling gas can be simplified. This results in a reduction of the cooling cost required to freeze the liquid film.

### TECHNICAL FIELD

The present invention relates to a substrate processing apparatus for and a substrate processing method of processing a substrate.

### BACKGROUND ART

Conventionally, in the manufacturing process of semiconductor substrates (hereinafter, simply referred to as “substrates”), various types of processing are performed on substrates that include an insulation film such as an oxide film, using a substrate processing apparatus. For example, cleaning processing is performed in which particles or the like adhering to the surface of a substrate is removed by supplying a cleaning liquid to the surface of the substrate.

Japanese Patent Application Laid-Open No. 2008-71875 discloses a technique for removing particles on the surface of a substrate by forming a liquid film of deionized water (DIW) or the like on the surface of the substrate, cooling and freezing the liquid film with cooling gas, and then thawing and removing the frozen film with a rinsing liquid. Japanese Patent Application Laid-Open No. 2009-254965 discloses a technique for, in the aforementioned freeze cleaning, supplying deionized water that is cooled to a temperature lower than room temperature, to the surface of a substrate and freezing the deionized water with cooling gas. Japanese Patent Application Laid-Open No. 2009-254965 describes that the cooling temperature of the deionized water is preferably lower than 10° C. and is preferably set to approximately 2° C. in consideration of, for example, the heat insulating structure of piping and the capability of a heat exchanger. Japanese Patent Application Laid-Open No. 2008-28008 discloses a technique for supplying a liquid cooling medium to the back surface of a substrate so as to freeze a liquid film of deionized water formed on the front surface of the substrate, and then thawing and removing the liquid film with a rinsing liquid. With the apparatuses disclosed in Japanese Patent Application Laid-Open Nos. 2008-71875, 2009-254965, and 2008-28008, a liquid film is formed on the surface of a substrate by rotating the substrate so as to remove part of the liquid that has been ejected onto the surface of the substrate from the substrate (i.e., spin the liquid off).

On the other hand, Japanese Patent Application Laid-Open No. 2000-58494 proposes a blast cleaning method of, when removing a photoresist film on a substrate, immersing the photoresist film in liquid nitrogen so as to freeze the photoresist film, and then spraying dry ice particles or ice particles onto the frozen film. It also proposes to soak the photoresist film with water before the photoresist film is frozen, using a method such as immersing the photoresist film in water or spraying water vapor to the photoresist film.

Incidentally, in the substrate processing apparatuses that perform freeze cleaning as described above, nitrogen gas or the like that has passed through piping running in liquid nitrogen and been cooled to approximately −190° C. is used as cooling gas for freezing a liquid film on a substrate. In order to introduce such cooling gas into a chamber in which the substrate is processed, high-performance heat insulating facilities are required, and the manufacturing cost of the apparatus increases. If, however, the performance of the heat insulating facilities is reduced, the temperature of the cooling gas will rise and accordingly the time required to freeze the liquid film will increase.

With the apparatus of Japanese Patent Application Laid-Open No. 2009-254965, the time required to freeze the liquid film can be shortened and the cooling cost required to freeze the liquid film can be reduced by forming the liquid film of cooled deionized water. However, there is a limit to the reduction in the time and the cooling cost required for freezing, because in the course of rotating a substrate and thereby forming a liquid film, the temperature of the liquid film will increase due to the entry of heat into the liquid film through gas or the like around the substrate.

With the apparatuses of Japanese Patent Application Laid-Open Nos. 2008-71875, 2009-254965, and 2008-28008 that remove particles or the like on the surface of a substrate, a mechanism for ejecting and supplying a liquid such as deionized water to the surface of a substrate is necessary in order to form a liquid film on the surface of the substrate. Furthermore, since the liquid film is formed by rotating the substrate and thereby moving the liquid on the substrate, if the thickness of the liquid film is reduced to a certain extent or more, an area where there is a liquid film and an area where there is no liquid film will both be present on the surface of the substrate.

### SUMMARY OF INVENTION

The present invention is intended for a technique for processing a substrate, and it is a primary object of the present invention to reduce the cooling cost required to freeze a liquid film and shorten the time required to freeze a liquid film. It is another object of the present invention to downsize a substrate processing apparatus by omitting a structure for ejecting a liquid toward a substrate. It is yet another object of the present invention to easily form a thin liquid film on a substrate.

A substrate processing apparatus according to an aspect of the present invention includes a chamber, a substrate holding part that holds a substrate with one major surface facing up in the chamber, a liquid supply part that supplies a supercooled liquid to the one major surface of the substrate, the supercooled liquid being supercooled to a temperature lower than a freezing point of the supercooled liquid, a substrate rotating mechanism that rotates the substrate that has been supplied with the supercooled liquid about an axis perpendicular to the one major surface, so as to form a liquid film on the one major surface, and a freezing part that cools and freezes the liquid film. With the substrate processing apparatus, the cooling cost required to freeze the liquid film can be reduced. It is also possible to shorten the time required to freeze the liquid film.

According to a preferred embodiment of the present invention, the formation of the liquid film by the substrate rotating mechanism is performed after a temperature of the one major surface is reduced to a temperature lower than the freezing point of the supercooled liquid by supplying the supercooled liquid from the liquid supply part to the one major surface of the substrate.

According to another preferred embodiment of the present invention, the substrate processing apparatus further includes a cooling part that cools the other major surface of the substrate that is being rotated, when the liquid film is formed.

More preferably, the cooling part supplies the supercooled liquid to the other major surface.

According to yet another embodiment of the present invention, the supercooled liquid is pure water.

According to yet another embodiment of the present invention, the substrate processing apparatus further includes a frozen-film removing part that supplies a heated thawing liquid to a frozen film so as to remove the frozen film, the frozen film being the liquid film that has been frozen.

A substrate processing apparatus according to another aspect of the present invention includes a chamber, a substrate holding part that holds a substrate with one major surface facing up in the chamber, a first liquid supply part that supplies a pre-cooled first liquid to the substrate so as to preliminarily cool the substrate, a second liquid supply part that supplies a second liquid to the one major surface of the preliminarily cooled substrate, the second liquid having a freezing point higher than or equal to a temperature of the first liquid, a substrate rotating mechanism that rotates the substrate that has been supplied with the second liquid about an axis perpendicular to the one major surface, so as to form a liquid film of the second liquid on the one major surface, and a freezing part that cools and freezes the liquid film. With the substrate processing apparatus, the cooling cost required to freeze the liquid film can be reduced. It is also possible to shorten the time required to freeze the liquid film.

According to a preferred embodiment of the present invention, the second liquid supply part supplies the second liquid that has been pre-cooled to the substrate.

According to another preferred embodiment of the present invention, the preliminary cooling by the first liquid supply part reduces a temperature of the substrate to a temperature lower than or equal to the freezing point of the second liquid.

According to yet another embodiment of the present invention, the substrate processing apparatus further includes a third liquid supply part that supplies a third liquid to the other major surface of the substrate, the third liquid having a freezing point higher than or equal to the temperature of the first liquid. With the substrate being rotated by the substrate rotating mechanism, the first liquid that is cooled to a temperature lower than or equal to the freezing point of the third liquid is supplied from the first liquid supply part to the one major surface of the substrate, and the third liquid is supplied from the third liquid supply part to the other major surface of the substrate.

According to yet another embodiment of the present invention, the first liquid supply part supplies the first liquid to the other major surface of the substrate.

According to yet another embodiment of the present invention, the second liquid is pure water.

According to yet another embodiment of the present invention, the first liquid is a functional fluid having etching capability.

According to yet another embodiment of the present invention, the substrate processing apparatus further includes a frozen-film removing part that supplies a heated thawing liquid to a frozen film so as to remove the frozen film, the frozen film being the liquid film that has been frozen.

A substrate processing apparatus according to yet another aspect of the present invention includes a chamber, a substrate holding part that holds a substrate with one major surface facing up in the chamber, a liquid supply part that supplies a liquid to the one major surface of the substrate, a substrate rotating mechanism that rotates the substrate that has been supplied with the liquid about an axis perpendicular to the one major surface, so as to form a liquid film of the liquid on the one major surface, a cooling part that cools the other major surface of the substrate that is being rotated, when the liquid film is formed, and a freezing part that cools and freezes the liquid film. With the substrate processing apparatus, the cooling cost required to freeze the liquid film can be reduced. It is also possible to shorten the time required to freeze the liquid film.

According to a preferred embodiment of the present invention, the cooling part supplies a cooled cooling liquid to the other major surface of the substrate.

More preferably, the cooling liquid is the same liquid as the liquid supplied from the liquid supply part.

According to another preferred embodiment of the present invention, the cooling part supplies cooled gas to the other major surface of the substrate.

According to yet another embodiment of the present invention, the liquid supplied from the liquid supply part is pure water.

According to yet another embodiment of the present invention, the substrate processing apparatus further includes a frozen-film removing part that supplies a heated thawing liquid to a frozen film so as to remove the frozen film, the frozen film being the liquid film that has been frozen.

A substrate processing apparatus according to yet another aspect of the present invention includes a chamber, a substrate holding part that holds a substrate in the chamber, a liquid film forming part that forms a liquid film on one major surface of the substrate by causing condensation of pure water on the one major surface, and a freezing part that cools and freezes the liquid film. With the substrate processing apparatus, it is possible to downsize the substrate processing apparatus by omitting the structure for ejecting a liquid toward the surface of a substrate. Also, a thin liquid film can be easily formed on the substrate.

According to a preferred embodiment of the present invention, the liquid film forming part serves as a substrate cooling part that cools the substrate.

More preferably, the substrate cooling part also serves as the freezing part.

More preferably, the substrate cooling part supplies cooling gas to the other major surface of the substrate.

Alternatively, the substrate processing apparatus further includes a substrate rotating mechanism that rotates the substrate about an axis perpendicular to the one major surface. With the substrate being rotated by the substrate rotating mechanism, cooling gas is supplied from the substrate cooling part to a center portion of the one major surface of the substrate or a center portion of the other major surface of the substrate.

As another alternative, the substrate processing apparatus further includes a substrate rotating mechanism that rotates the substrate about an axis perpendicular to the one major surface. The substrate cooling part includes a cooling gas nozzle that supplies cooling gas to the substrate, and a nozzle moving mechanism that reciprocally moves the cooling gas nozzle relative to the substrate between a center portion and an outer edge portion of the substrate. With the substrate being rotated by the substrate rotating mechanism, cooling gas is supplied from the cooling gas nozzle that is reciprocally moved by the nozzle moving mechanism to the one major surface or the other major surface of the substrate.

More preferably, the substrate processing apparatus further includes a cooling gas temperature control part that controls a temperature of the cooling gas supplied from the substrate cooling part to the substrate. A temperature of the cooling gas that is supplied from the cooling gas nozzle to the outer edge portion of the substrate is lower than a temperature of the cooling gas that is supplied from the cooling gas nozzle to the center portion of the substrate.

According to another preferred embodiment of the present invention, the substrate processing apparatus further includes a humidity control part that controls humidity in the chamber.

According to yet another embodiment of the present invention, the substrate processing apparatus further includes a frozen-film removing part that supplies a heated thawing liquid to a frozen film so as to remove the frozen film, the frozen film being the liquid film that has been frozen.

The present invention is also intended for a substrate processing method of processing a substrate. A substrate processing method according to an aspect of the present invention includes the steps of a) supplying a supercooled liquid to one major surface of a substrate that is held with the one major surface facing up in a chamber, the supercooled liquid being supercooled to a temperature lower than a freezing point of the supercooled liquid, b) forming a liquid film on the one major surface by rotating the substrate about an axis perpendicular to the one major surface, and c) cooling and freezing the liquid film.

A substrate processing method according to another aspect of the present invention includes the steps of a) supplying a pre-cooled first liquid to a substrate that is held with one major surface facing up in a chamber, so as to preliminarily cool the substrate, b) supplying a second liquid to the one major surface of the substrate and rotating the substrate about an axis perpendicular to the one major surface so as to form a liquid film of the second liquid on the one major surface, the second liquid having a freezing point higher than or equal to a temperature of the first liquid, and c) cooling and freezing the liquid film.

A substrate processing method according to yet another aspect of the present invention includes the steps of a) supplying a liquid to one major surface of a substrate that is held with the one major surface facing up in a chamber, b) forming a liquid film of the liquid on the one major surface by rotating the substrate about an axis perpendicular to the one major surface while cooling the other major surface of the substrate, and c) cooling and freezing the liquid film.

A substrate processing apparatus according to yet another aspect of the present invention includes the steps of a) forming a liquid film on one major surface of a substrate by causing condensation of pure water on the one major surface in a chamber, and b) cooling and freezing the liquid film.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 shows a configuration of a substrate processing apparatus according to a first embodiment;

FIG. 2 is a flowchart of processing a substrate;

FIG. 3 shows a configuration of a substrate processing apparatus according to a second embodiment;

FIG. 4A is a flowchart of processing a substrate;

FIG. 4B is a flowchart of processing a substrate;

FIG. 5 shows a configuration of a substrate processing apparatus according to a third embodiment;

FIG. 6 is a flowchart of processing a substrate;

FIG. 7 shows a configuration of a substrate processing apparatus according to a fourth embodiment;

FIG. 8 is a flowchart of processing a substrate;

FIG. 9 shows the relationship between the liquid-film forming time and the thickness and temperature of the liquid film in a substrate processing apparatus according to a comparative example;

FIG. 10 shows a configuration of a substrate processing apparatus according to a fifth embodiment;

FIG. 11 is a flowchart of processing a substrate; and

FIG. 12 shows a configuration of a substrate processing apparatus according to a sixth embodiment.

### DESCRIPTION OF EMBODIMENTS

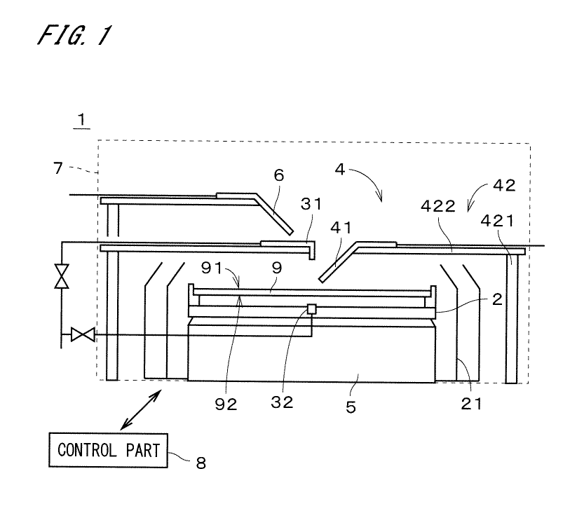

FIG. 1 shows a configuration of a substrate processing apparatus 1 according to a first embodiment of the present invention. As shown in FIG. 1, the substrate processing apparatus 1 is a single-wafer processing apparatus that processes semiconductor substrates 9 (hereinafter, simply referred to as “substrates 9”) one at a time. The substrate processing apparatus 1 performs freeze cleaning processing in which a frozen film is formed on a substrate 9 and then removed so as to remove particles or the like from the substrate 9.

The substrate processing apparatus 1 includes a substrate holding part 2, a cup part 21, a first liquid supply part 31, a second liquid supply part 32, a freezing part 4, a substrate rotating mechanism 5, a heating liquid supply part 6, a chamber 7, and a control part 8. The control part 8 controls constituent elements such as the first liquid supply part 31, the second liquid supply part 32, the freezing part 4, the substrate rotating mechanism 5, and the heating liquid supply part 6, for example. The substrate holding part 2 holds a substrate 9 with one major surface 91 (hereinafter, referred to as an “upper surface 91”) of the substrate 9 facing up in the chamber 7. A circuit pattern, for example, is formed on the upper surface 91 of the substrate 9. The cup part 21 surrounds the substrate 9 and the substrate holding part 2 in the chamber 7. The substrate rotating mechanism 5 rotates the substrate 9 together with the substrate holding part 2 in a horizontal plane about a rotation axis that passes through the center of the substrate 9 and is perpendicular to the upper surface 91 of the substrate 9.

The first liquid supply part 31 supplies a supercooled liquid to the upper surface 91 of the substrate 9, the supercooled liquid being a liquid that is supercooled to a temperature lower than its freezing point. The term “supercooling” as used herein refers to a state in which a substance is at or below the temperature of phase change, without the phase change taking place. In the present embodiment, a supercooled liquid that is pure water supercooled to a temperature lower than 0° C. (e.g., approximately −5° C.) is ejected from the first liquid supply part 31 to a center portion of the upper surface 91 of the substrate 9. Also, the same supercooled liquid as that supplied from the first liquid supply part 31 is ejected from the second liquid supply part 32 to a center portion of the other major surface 92 (hereinafter, referred to as a “lower surface 92”) of the substrate 9. A preferable example of the supercooled liquid being used is deionized water (DIW).

The freezing part 4 supplies cooling gas to the upper surface 91 of the substrate 9. The cooling gas is gas that is cooled to a temperature lower than the freezing point of the supercooled liquid supplied from the first liquid supply part 31. The freezing point of the supercooled liquid as used here refers to a temperature at which a liquid used as the supercooled liquid solidifies without being supercooled. The freezing part 4 includes a cooling gas nozzle 41 that ejects the cooling gas and a nozzle turning mechanism 42 for turning the cooling gas nozzle 41 horizontally about a rotation shaft 421. The nozzle turning mechanism 42 is provided with an arm 422 that extends in a horizontal direction from the rotation shaft 421 and to which the cooling gas nozzle 41 is attached. An example of the cooling gas being used is cooled nitrogen (N₂) gas. The temperature of the cooling gas is preferably in the range of −100 to −20° C., and in the present embodiment, it is approximately −50° C.

The heating liquid supply part 6 supplies a heating liquid, which is a liquid that has been heated, to the center portion of the upper surface 91 of the substrate 9. In FIG. 1, for the convenience of illustration, the heating liquid supply part 6 is illustrated above the first liquid supply part 31, but in actuality the heating liquid supply part 6 is moved from the outside to above the substrate 9 in a state in which the first liquid supply part 31 has been retracted from above the substrate 9 toward the outside. When the first liquid supply part 31 is above the substrate 9, the heating liquid supply part 6 is retracted from above the substrate 9 toward the outside. An example of the heating liquid being used is pure water (preferably, deionized water) that is heated to a temperature higher than room temperature. The temperature of the heating liquid is preferably in the range of 50 to 90° C., and in the present embodiment, it is approximately 80° C.

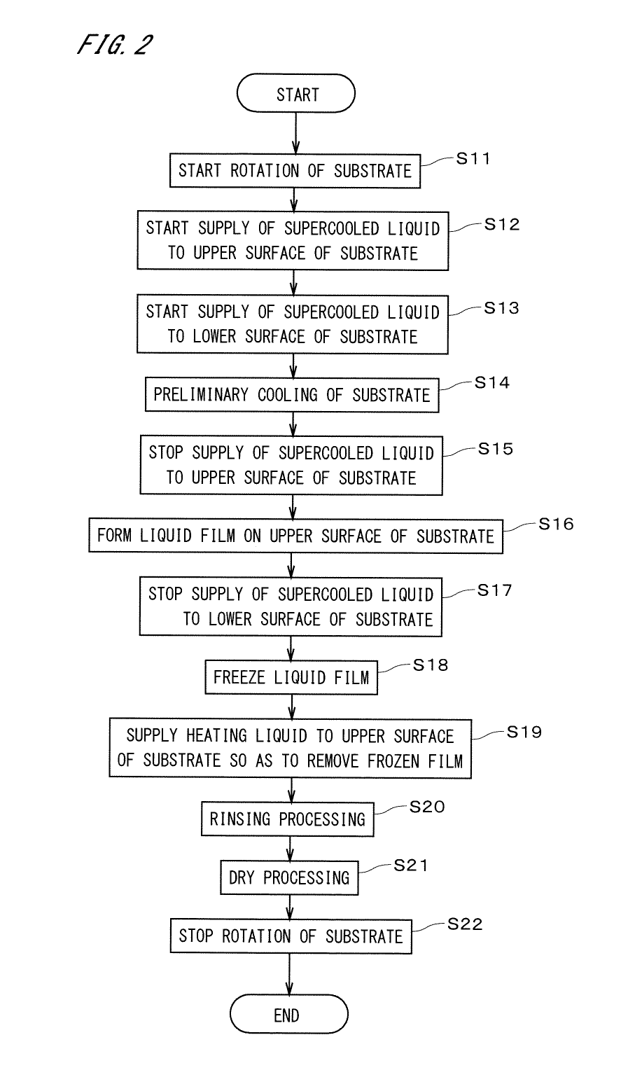

FIG. 2 is a flowchart of processing the substrate 9, performed by the substrate processing apparatus 1. In the substrate processing apparatus 1, first, the substrate 9 is transported into the chamber 7 and held by the substrate holding part 2, and the substrate rotating mechanism 5 starts rotating the substrate 9 under the control of the control part 8 (step S11). The number of revolutions of the substrate 9 is, for example, in the range of 300 to 900 rpm, and in the present embodiment, it is 400 rpm.

Then, the control part 8 controls the first liquid supply part 31 and the second liquid supply part 32 so that the supply of the supercooled liquid from the first liquid supply part 31 to the upper surface 91 of the substrate 9 is started, and the supply of the supercooled liquid from the second liquid supply part 32 to the lower surface 92 of the substrate 9 is started (steps S12 and S13). By the rotation of the substrate 9, the supercooled liquids supplied to the upper surface 91 and the lower surface 92 of the substrate 9 spread from the center portion of the substrate 9 to the outer edge portion thereof and over the enter upper surface 91 and the entire lower surface 92 and are scattered from the edge of the substrate 9 to the outside. The supercooled liquid scattered from the substrate 9 is received and collected by the cup part 21.

In the substrate processing apparatus 1, the supply of the supercooled liquid from the first liquid supply part 31 and the second liquid supply part 32 is continued for a predetermined period of time. Then, the substrate 9 is cooled until at least the temperature of the upper surface 91 of the substrate 9 is reduced to a temperature lower than 0° C. (i.e., the freezing point of the supercooled liquid) (step S14). More preferably, the supply of the supercooled liquid to the upper surface 91 and the lower surface 92 of the substrate 9 is continued until the temperature of the entire substrate 9 is reduced to a temperature lower than 0° C. In the following description, the cooling of the substrate 9 in step S14 is referred to as “preliminary cooling”. In the present embodiment, the entire substrate 9 is cooled to approximately −1° C. by the preliminary cooling.

Thereafter, the rotating speed of the substrate 9 by the substrate rotating mechanism 5 is decreased to the rotating speed lower than that when preliminarily cooling the substrate 9 with the supercooled liquid. The number of revolutions of the substrate 9 is, for example, in the range of 50 to 300 rpm, and in the present embodiment, it is 80 rpm. Then, the supply of the supercooled liquid from the first liquid supply part 31 to the upper surface 91 of the substrate 9 is stopped (step S15). In the substrate processing apparatus 1, on the upper surface 91 of the substrate 9 being rotated at a low speed, part of the supercooled liquid remaining on the upper surface 91 flows from the center portion of the substrate 9 to the edge thereof and is scattered from the substrate 9 to the outside. Then, a thin liquid film of the supercooled liquid is formed on the upper surface 91 of the substrate 9 (step S16). The thickness of the liquid film is substantially uniform over the entire upper surface 91 of the substrate 9, and in the present embodiment, it is approximately 50 μm. Note that the thickness of the liquid film does not necessarily have to be uniform.

In the substrate processing apparatus 1, even when the liquid film is formed on the upper surface 91 of the substrate 9, the supercooled liquid is continuously supplied from the second liquid supply part 32 to the lower surface 92 of the rotating substrate 9, and the lower surface 92 of the substrate 9 is cooled. In other words, the second liquid supply part 32 is a cooling part that cools the lower surface 92 of the substrate 9 even during the formation of the liquid film.

When the formation of the liquid film has finished, the supply of the supercooled liquid from the second liquid supply part 32 is stopped (step S17). Then, the nozzle turning mechanism 42 of the freezing part 4 starts turning the cooling gas nozzle 41 under the control of the control part 8, and the cooling gas nozzle 41 repeats its reciprocal movements between the center portion of the substrate 9 and the edge thereof. Then, cooling gas is supplied from a cooling gas supply source provided outside the substrate processing apparatus 1 to the cooling gas nozzle 41 and is then supplied from the cooling gas nozzle 41 to the upper surface 91 of the rotating substrate 9. As a result, the cooling gas is supplied over the entire upper surface 91 of the substrate 9, and the liquid film on the upper surface 91 is cooled and frozen (step S18). Hereinafter, the liquid film that has been frozen is referred to as a “frozen film”. Note that in the substrate processing apparatus 1, the frozen film may be formed by supplying cooling gas from the cooling gas nozzle 41 that has stopped above the center portion of the substrate 9 and causing the cooling gas to spread from the center portion of the substrate 9 to the outer edge portion thereof by the rotation of the substrate 9.

On the substrate 9, the supercooled liquid that has entered between the substrate 9 and particles or the like is frozen (solidifies) and increases in volume, thereby lifting the particles or the like off from the substrate 9 by a small distance. As a result, the adhesion strength between the particles or the like and the substrate 9 is reduced, and the particles or the like are detached from the substrate 9. The particles or the like adhering to the substrate 9 will also fall off from the substrate 9 as a result of the supercooled liquid increasing in volume in a direction parallel to the upper surface 91 of the substrate 9 when it is frozen.

When the formation of the frozen film has finished, the supply of the cooling gas from the freezing part 4 is stopped, and the cooling gas nozzle 41 is moved from above the substrate 9 toward the outside. Then, the rotating speed of the substrate 9 by the substrate rotating mechanism 5 is increased to the rotating speed higher than that when forming the frozen film. The number of revolutions of the substrate 9 is, for example, in the range of 1500 to 2500 rpm, and in the present embodiment, it is 2000 rpm.

Next, the heating liquid supply part 6 is controlled by the control part 8 so that a heating liquid is supplied from the heating liquid supply part 6 to the upper surface 91 of the substrate 9. By the rotation of the substrate 9, the heating liquid spreads from the center portion of the substrate 9 to the outer edge portion thereof and over the entire upper surface 91. This causes the frozen film on the upper surface 91 to be rapidly thawed (i.e., liquefied) and scattered from the edge of the substrate 9 to the outside, together with the heating liquid (step S19). Particles or the like adhering to the upper surface 91 of the substrate 9 are removed from the substrate 9, together with the liquid scattered from the substrate 9. The liquid scattered from the substrate 9 to the outside is received and collected by the cup part 21. In the substrate processing apparatus 1, the heating liquid supply part 6 serves as a frozen-film removing part that supplies a heating liquid serving as a thawing liquid to the frozen film on the substrate 9 so as to remove the frozen film.

When the removal of the frozen film has finished, a rinsing liquid (e.g., deionized water having room temperature) is supplied from a rinsing liquid supply part (not shown) to the upper surface 91 of the substrate 9, and processing for rinsing the substrate 9 is performed (step S20). The number of revolutions of the substrate 9 during the rinsing processing is preferably in the range of 300 to 1000 rpm, and in the present embodiment, it is 800 rpm. Thereafter, the number of revolutions of the substrate 9 is changed to the range of 1500 to 3000 rpm (in the present embodiment, 2000 rpm), and dry processing for removing the rinsing liquid on the substrate 9 is performed by the rotation of the substrate 9 (step S21). After the dry processing of the substrate 9 has finished, the rotation of the substrate 9 by the substrate rotating mechanism 5 is stopped (step S22).

As described above, in the substrate processing apparatus 1, a liquid film of the supercooled liquid supplied to the upper surface 91 of the substrate 9 is formed on the upper surface 91, and that liquid film is cooled with the cooling gas supplied from the freezing part 4 into a frozen film. The liquid film formed of the supercooled liquid has a temperature lower than the freezing point of the liquid (pure water) and is in a easy-to-freeze state as compared with pure water having a temperature higher than its freezing point. It is thus possible to shorten the time required to freeze the liquid film (i.e., a phase change time required for the liquid to change into a solid state) during cooling by the freezing part 4. Also, reducing the phase change time can improve the removal rate of particles or the like.

With the substrate processing apparatus 1, even if the temperature of the cooling gas supplied from the freezing part 4 is increased, the liquid film can be speedily frozen as compared with the case where the liquid film is formed of pure water having a temperature higher than its freezing point. Thus, it is possible to simplify heat insulating facilities such as piping that supply the cooling gas from the cooling gas supply source to the cooling gas nozzle 41. As a result, the cooling cost required to freeze the liquid film using the freezing part 4 can be reduced. Note that the phase change time becomes shorter as the supercooling range that is a difference between the temperature of the liquid film in a supercooled state and the freezing point increases.

In the substrate processing apparatus 1, as described above, the supercooled liquid is supplied from the first liquid supply part 31 and the second liquid supply part 32 to the upper surface 91 and the lower surface 92 of the substrate 9, and the liquid film is formed on the substrate 9 after the temperature of the substrate 9 is reduced to a temperature lower than the freezing point of the supercooled liquid. This prevents the liquid film from absorbing the heat of the substrate 9, thus suppressing an increase in the temperature of the liquid film. As a result, the time required to freeze the liquid film can be further shortened. Also, the cooling cost required to freeze the liquid film can be further reduced.

With the substrate processing apparatus 1, an increase in the temperatures of the substrate 9 and the liquid film during the formation of the liquid film can be further suppressed because the lower surface 92 of the substrate 9 is cooled by the second liquid supply part 32 serving as a cooling part when the liquid film is formed. Thus, the time required to form the liquid film can be even further shortened. Also, the cooling cost required to freeze the liquid film can be further reduced. As described above, the liquid supplied from the second liquid supply part 32 to the lower surface 92 is the same liquid as the supercooled liquid supplied from the first liquid supply part 31 to the upper surface 91. This can simplify the structure of the substrate processing apparatus 1 by, for example, sharing part of the piping between the first liquid supply part 31 and the second liquid supply part 32. It is also possible to collect the liquid supplied to the upper surface 91 and the lower surface 92 of the substrate 9 and reuse the collected liquid for the processing of the substrate processing apparatus 1.

Since, as described above, the frozen film on the substrate 9 is formed of pure water having a relatively high volume expansion coefficient, the adhesion strength of particles or the like to the substrate 9 can be even further reduced as compared with the case where the frozen film is formed of any other liquid. This results in an improvement in the removal rate of particles or the like from the substrate 9. Furthermore, particles or the like adhering to the substrate 9 can be efficiently removed together with the frozen film by supplying the heating liquid so as to remove the frozen film from the substrate 9. In the substrate processing apparatus 1, by using the same supercooled liquid as that supplied from the first liquid supply part 31 and the second liquid supply part 32 as the heating liquid, it is possible to collect and reuse the liquid scattered from the substrate 9 when the frozen film is thawed.

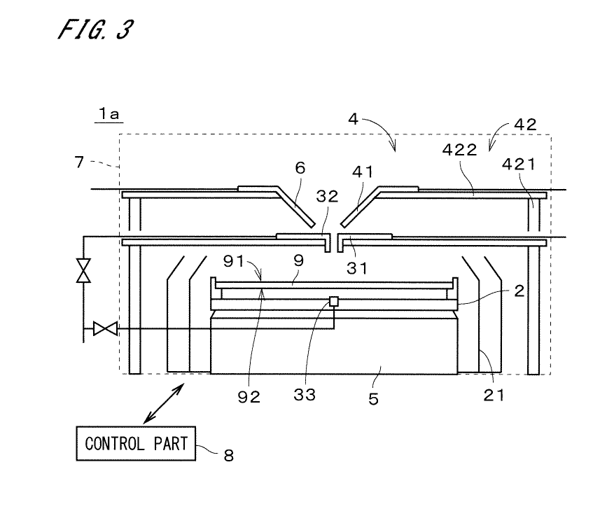

FIG. 3 shows a configuration of a substrate processing apparatus 1a according to a second embodiment of the present invention. As shown in FIG. 3, the substrate processing apparatus 1a is a single-wafer processing apparatus that processes semiconductor substrates 9 (hereinafter, simply referred to as “substrates 9”) one at a time. The substrate processing apparatus 1a performs freeze cleaning processing in which a frozen film is formed on a substrate 9 and then removed so as to remove particles or the like from the substrate 9.

The substrate processing apparatus 1a includes a substrate holding part 2, a cup part 21, a first liquid supply part 31, a second liquid supply part 32, a third liquid supply part 33, a freezing part 4, a substrate rotating mechanism 5, a heating liquid supply part 6, a chamber 7, and a control part 8. The control part 8 controls constituent elements such as the first liquid supply part 31, the second liquid supply part 32, the third liquid supply part 33, the freezing part 4, the substrate rotating mechanism 5, and the heating liquid supply part 6, for example. The substrate holding part 2 holds a substrate 9 with one major surface 91 (hereinafter, referred to as an “upper surface 91”) of the substrate 9 facing up in the chamber 7. A circuit pattern, for example, is formed on the upper surface 91 of the substrate 9. The cup part 21 surrounds the substrate 9 and the substrate holding part 2 in the chamber 7. The substrate rotating mechanism 5 rotates the substrate 9 together with the substrate holding part 2 in a horizontal plane about a rotation axis that passes through the center of the substrate 9 and is perpendicular to the upper surface 91 of the substrate 9.

The first liquid supply part 31 supplies a first liquid to a center portion of the upper surface 91 of the substrate 9, the first liquid being pre-cooled to a temperature lower than room temperature. The second liquid supply part 32 supplies a second liquid to the center portion of the upper surface 91 of the substrate 9, the second liquid having a freezing point higher than or equal to the temperature of the first liquid supplied from the first liquid supply part 31. The second liquid supplied from the second liquid supply part 32 is also pre-cooled to a temperature lower than room temperature.

A variety of liquids such as pure water, carbonated water, hydrogen water, SCl (ammonia-hydrogen peroxide mixture), and tert-Butanol (TBA) are used as the second liquid. Preferably, pure water having a freezing point of 0° C., and more preferably deionized water (DIW), is used as the second liquid. The first liquid supply part 31 supplies a variety of liquids that have temperatures lower than or equal to the freezing point of the second liquid, as the first liquid. Preferably, a functional fluid such as SCl, hydrofluoric acid, or ammonia water that has etching capability is used as the first liquid. The freezing point of TBA is 25.7° C., and the freezing point of hydrofluoric acid is −35° C. The freezing point of SCl varies depending on the mixing ratio of components, but it is approximately −10° C. or lower.

The third liquid supply part 33 supplies a third liquid to a center portion of the other major surface 92 (hereinafter, referred to as a “lower surface 92”) of the substrate 9, the third liquid having a freezing point higher than or equal to the temperature of the first liquid supplied from the first liquid supply part 31. Like the second liquid, a variety of liquids such as pure water, SCl (ammonia-hydrogen peroxide mixture), and tert-Butanol (TBA) are used as the third liquid. Preferably, pure water, and more preferably deionized water, is used as the third liquid. In the present embodiment, hydrofluoric acid is used as the first liquid, and pure water is used as the second liquid and the third liquid. Note that the third liquid does not necessarily have to be the same liquid as the second liquid.

The freezing part 4 supplies cooling gas to the upper surface 91 of the substrate 9. The cooling gas is gas that is cooled to a temperature lower than the freezing point of the second liquid supplied from the second liquid supply part 32. In FIG. 3, for the convenience of illustration, the freezing part 4 is illustrated above the first liquid supply part 31, but in actuality the freezing part 4 is moved from the outside to above the substrate 9 in a state in which the first liquid supply part 31 has been retracted from above the substrate 9 toward the outside. When the first liquid supply part 31 is above the substrate 9, the freezing part 4 is retracted from above the substrate 9 toward the outside.

The freezing part 4 includes a cooling gas nozzle 41 that ejects the cooling gas, and a nozzle turning mechanism 42 for turning the cooling gas nozzle 41 horizontally about a rotation shaft 421. The nozzle turning mechanism 42 is provided with an arm 422 that extends in a horizontal direction from the rotation shaft 421 and to which the cooling gas nozzle 41 is attached. An example of the cooling gas being used is cooled nitrogen (N₂) gas. The temperature of the cooling gas is preferably in the range of −100 to −20° C., and in the present embodiment, it is approximately −50° C.

The heating liquid supply part 6 supplies a heating liquid, which is a liquid that has been heated, to the center portion of the upper surface 91 of the substrate 9. In FIG. 3, for the convenience of illustration, the heating liquid supply part 6 is illustrated above the second liquid supply part 32, but in actuality the heating liquid supply part 6 is moved from the outside to above the substrate 9 in a state in which the second liquid supply part 32 has been retracted from above the substrate 9 toward the outside. When the second liquid supply part 32 is above the substrate 9, the heating liquid supply part 6 is retracted from above the substrate 9 toward the outside. An example of the heating liquid being used is pure water (preferably, deionized water) that is heated to a temperature higher than room temperature. The temperature of the heating liquid is preferably in the range of 50 to 90° C., and in the present embodiment, it is approximately 80° C.

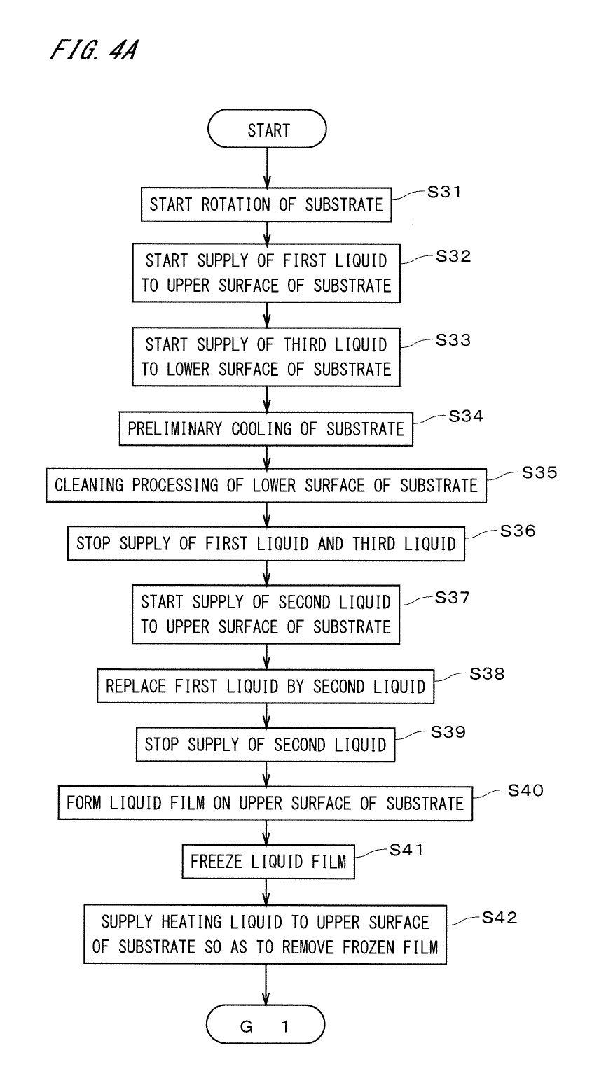

FIGS. 4A and 4B are flowcharts of processing the substrate 9, performed by the substrate processing apparatus 1a. In the substrate processing apparatus 1a, first, the substrate 9 is transported into the chamber 7 and held by the substrate holding part 2, and the substrate rotating mechanism 5 starts rotating the substrate 9 under the control of the control part 8 (step S31). The number of revolutions of the substrate 9 is, for example, in the range of 300 to 900 rpm, and in the present embodiment, it is 400 rpm.

Then, the control part 8 controls the first liquid supply part 31 and the third liquid supply part 33 so that the supply of the first liquid from the first liquid supply part 31 to the upper surface 91 of the substrate 9 is started, and the supply of the third liquid from the third liquid supply part 33 to the lower surface 92 of the substrate 9 is started (steps S32 and S33). The first liquid is pre-cooled to a temperature (e.g., in the range of −5 to 0° C.) lower than or equal to the freezing point of the second liquid and the third liquid. The third liquid is also pre-cooled to a temperature lower than room temperature.

By the rotation of the substrate 9, the first liquid and the third liquid supplied respectively to the upper surface 91 and the lower surface 92 of the substrate 9 spread from the center portion of the substrate 9 to the outer edge portion thereof and over the entire upper surface 91 and the entire lower surface 92 and are scattered from the edge of the substrate 9 to the outside. The liquids scattered from the substrate 9 are received and collected by the cup part 21.

In the substrate processing apparatus 1a, the supply of the first liquid from the first liquid supply part 31 to the upper surface 91 of the substrate 9 is continued for a predetermined period of time while the substrate 9 is being rotated by the substrate rotating mechanism 5. This cools the substrate 9 to a temperature lower than or equal to 0° C. (i.e., the freezing point of the second liquid and the third liquid) (step S34). In the following description, the cooling of the substrate 9 in step S34 is referred to as “preliminary cooling” (the same applies to step S53 that will be described later). In the present embodiment, the entire substrate 9 is cooled to approximately −5° C. by the preliminary cooling.

In the substrate processing apparatus 1a, in parallel with the preliminary cooling by the first liquid supply part 31, the supply of the third liquid from the third liquid supply part 33 to the lower surface 92 of the substrate 9 is continued for a predetermined period of time. Since, as described above, the temperature of the substrate 9 is reduced to a temperature lower than or equal to the freezing point of the third liquid by the preliminary cooling, part of the third liquid supplied to the lower surface 92 of the substrate 9 solidifies into solidified granules. The solidified granules then move together with the third liquid in a fluid form from the center portion of the lower surface 92 of the substrate 9 to the outer edge portion thereof, during which the solidified granules collide with particles or the like, and as a result, particles or the like are removed from the lower surface 92 of the substrate 9. In other words, processing for cleaning the lower surface 92 of the substrate 9 is performed using the third liquid supplied from the third liquid supply part 33 (step S35).

When the preliminary cooling of the substrate 9 and the cleaning of the lower surface 92 using the third liquid have finished, the supply of the first liquid from the first liquid supply part 31 and the supply of the third liquid from the third liquid supply part 33 are stopped (step S36). Then, the control part 8 controls the second liquid supply part 32 so that the supply of the second liquid to the center portion of the upper surface 91 of the preliminarily cooled substrate 9 is started, the second liquid being pre-cooled to a temperature (e.g., 1° C.) lower than room temperature (step S37). By the rotation of the substrate 9, the second liquid supplied to the upper surface 91 of the substrate 9 spreads from the center portion of the substrate 9 to the outer edge portion thereof. The first liquid remaining on the upper surface 91 of the substrate 9 is pushed out by the second liquid and removed from the upper surface 91. In other words, the first liquid on the upper surface 91 of the substrate 9 is replaced by the second liquid supplied from the second liquid supply part 32 (step S38).

When the replacement of the first liquid on the substrate 9 by the second liquid has finished, the rotating speed of the substrate 9 by the substrate rotating mechanism 5 is decreased to the rotating speed lower than that when replacing the liquid. The number of revolutions of the substrate 9 is, for example, in the range of 50 to 300 rpm, and in the present embodiment, it is 80 rpm. Then, the supply of the second liquid from the second liquid supply part 32 is stopped (step S39). In the substrate processing apparatus 1a, on the upper surface 91 of the substrate 9 being rotated at a low speed, part of the second liquid supplied to the upper surface 91 flows from the center portion of the substrate 9 to the edge thereof and is scattered from the substrate 9 to the outside. Then, a thin liquid film of the second liquid is formed on the upper surface 91 of the substrate 9 (step S40). The thickness of the liquid film is substantially uniform over the entire upper surface 91 of the substrate 9, and in the present embodiment, it is approximately 50 m. Note that the thickness of the liquid film does not necessarily have to be uniform.

When the formation of the liquid film has finished, the nozzle turning mechanism 42 of the freezing part 4 starts turning the cooling gas nozzle 41 under the control of the control part 8, and the cooling gas nozzle 41 repeated its reciprocal movements between the center portion of the substrate 9 and the edge thereof. Then, cooling gas is supplied from a cooling gas supply source provided outside the substrate processing apparatus 1a to the cooling gas nozzle 41 and is then supplied from the cooling gas nozzle 41 to the upper surface 91 of the rotating substrate 9. As a result, the cooling gas is supplied over the entire upper surface 91 of the substrate 9, and the liquid film of the second liquid on the upper surface 91 is cooled and frozen (step S41). Hereinafter, the liquid film that has been frozen is also referred to as a “frozen film”. Note that in the substrate processing apparatus 1a, the frozen film may be formed by supplying cooling gas from the cooling gas nozzle 41 that has stopped above the center portion of the substrate 9 and causing the cooling gas to spread from the center portion of the substrate 9 to the outer edge portion thereof by the rotation of the substrate 9 (the same applies to a substrate processing apparatus 1b that will be described later).

On the substrate 9, the second liquid that has entered between the substrate 9 and particles or the like is frozen (solidifies) and increases in volume, thereby lifting the particles or the like off from the substrate 9 by a small distance. As a result, the adhesion strength between the particles or the like and the substrate 9 is reduced, and the particles or the like are detached from the substrate 9. The particles or the like adhering to the substrate 9 will also fall off from the substrate 9 as a result of the second liquid increasing in volume in a direction parallel to the upper surface 91 of the substrate 9 when it is frozen.

When the formation of the frozen film has finished, the supply of the cooling gas from the freezing part 4 is stopped, and the cooling gas nozzle 41 is moved from above the substrate 9 toward the outside. Then, the rotating speed of the substrate 9 by the substrate rotating mechanism 5 is increased to the rotating speed higher than that when forming the frozen film. The number of revolutions of the substrate 9 is, for example, in the range of 1500 to 2500 rpm, and in the present embodiment, it is 2000 rpm.

Next, the heating liquid supply part 6 is controlled by the control part 8 so that a heating liquid is supplied from the heating liquid supply part 6 to the upper surface 91 of the substrate 9. By the rotation of the substrate 9, the heating liquid spreads from the center portion of the substrate 9 to the outer edge portion thereof and over the entire upper surface 91. This causes the frozen film on the upper surface 91 to be rapidly thawed (i.e., liquefied) and scattered from the edge of the substrate 9 to the outside, together with the heating liquid (step S42). Particles or the like adhering to the upper surface 91 of the substrate 9 are removed from the substrate 9, together with the liquid scattered from the substrate 9. The liquid scattered from the substrate 9 to the outside is received and collected by the cup part 21. In the substrate processing apparatus 1a, the heating liquid supply part 6 serves as a frozen-film removing part that supplies a heating liquid serving as a thawing liquid to the frozen film on the substrate 9 so as to remove the frozen film.

When the removal of the frozen film has finished, a rinsing liquid (e.g., deionized water having room temperature) is supplied from a rinsing liquid supply part (not show) to the upper surface 91 of the substrate 9, and processing for rinsing the substrate 9 is performed (step S43). The number of revolutions of the substrate 9 during the rinsing processing is preferably in the range of 300 to 1000 rpm, and in the present embodiment, it is 800 rpm. Thereafter, the number of revolutions of the substrate 9 is changed to the range of 1500 to 3000 rpm (in the present embodiment, 2000 rpm), and dry processing for removing the rinsing liquid on the substrate 9 is performed by the rotation of the substrate 9 (step S44). When the drying processing of the substrate 9 has finished, the rotation of the substrate 9 by the substrate rotating mechanism 5 is stopped (step S45).

As described above, in the substrate processing apparatus 1a, after the substrate 9 is preliminarily cooled with the first liquid having a temperature lower than or equal to the freezing point of the second liquid, a liquid film of the second liquid is formed on the upper surface 91 of the substrate 9, and that liquid film is cooled with the cooling gas supplied from the freezing part 4 into a frozen film. This prevents the liquid film from absorbing the heat of the substrate 9, thus suppressing an increase in the temperature of the liquid film. As a result, the time required to freeze the liquid film can be shortened. Furthermore, even if the temperature of the cooling gas supplied from the freezing part 4 is increased, the liquid film can be speedily frozen as compared with the case where the liquid film is formed and frozen without performing the preliminary cooling of the substrate 9. It is thus possible to simplify heat insulating facilities such as piping that supply the cooling gas from the cooling gas supply source to the cooling gas nozzle 41. As a result, the cooling cost required to freeze the liquid film using the freezing part 4 can be reduced.

In the substrate processing apparatus 1a, the substrate 9 is cooled to a temperature lower than or equal to the freezing point of the second liquid by the preliminary cooling of the substrate 9 by the first liquid supply part 31. This prevents the liquid film on the upper surface 91 of the substrate 9 from absorbing the heat of the substrate 9, thus suppressing an increase in the temperature of the liquid film. As a result, the time required to freeze the liquid film can be even further shortened. Also, the cooling cost required to freeze the liquid film using the freezing part 4 can be even further reduced. Furthermore, by pre-cooling the second liquid supplied from the second liquid supply part 32, it is possible to even further shorten the time required to freeze the liquid film and even further reduce the cooling cost required to freeze the liquid film.

As described above, in the substrate processing apparatus 1a, the adhesion strength between particles or the like and the substrate 9 can be further reduced by supplying the first liquid that serves as a functional fluid having etching capability to the upper surface 91 of the substrate 9 during the preliminary cooling of the substrate 9. As a result, the removal rate of particles or the like from the substrate 9 can be improved. Furthermore, part of the third liquid supplied from the third liquid supply part 33 to the lower surface 92 of the substrate 9 solidifies into solidified granules and collides with particles or the like during the preliminary cooling of the substrate 9. This makes it possible to remove particles or the like adhering to the lower surface 92 of the substrate 9. Moreover, since the third liquid supplied from the third liquid supply part 33 to the substrate 9 is pre-cooled, part of the third liquid can speedily solidify into solidified granules.

Since the frozen film on the substrate 9 is formed of pure water having a relatively high volume expansion coefficient, the adhesion strength of particles or the like to the substrate 9 can be even further reduced as compared with the case where the frozen film is formed of any other liquid. This results in an improvement in the removal rate of particles or the like from the substrate 9. Furthermore, by supplying a heating liquid so as to remove the frozen film from the substrate 9, particles or the like adhering to the substrate 9 can be efficiently removed together with the frozen film. In the substrate processing apparatus 1a, the same liquid as the second liquid forming the frozen film is used as the heating liquid, and thus it is also possible to collect and reuse the liquid scattered from the substrate 9 when the frozen film is thawed.

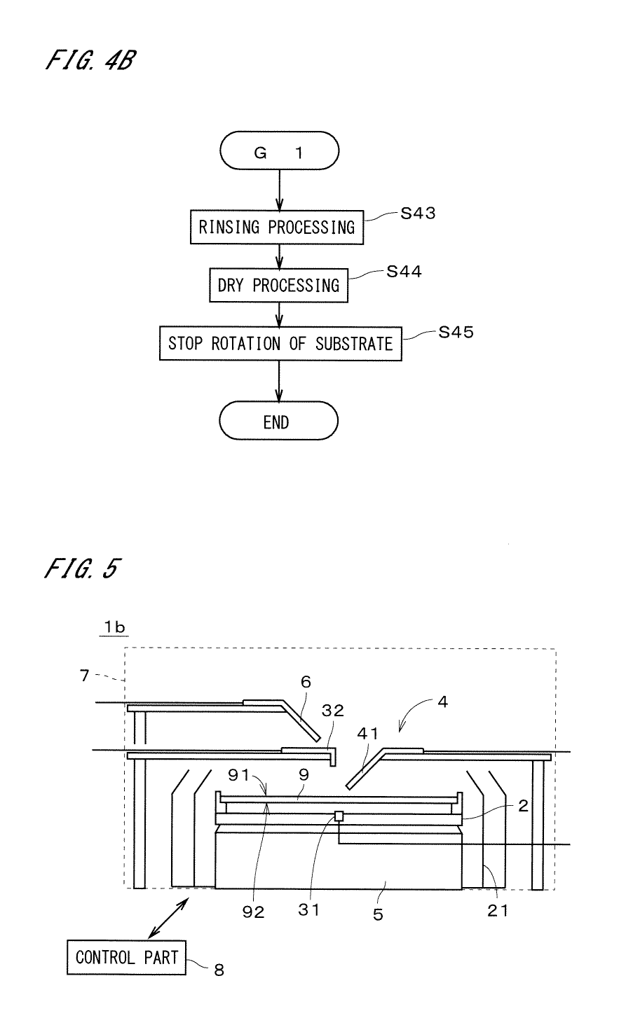

Next is a description of a substrate processing apparatus according to a third embodiment of the present invention. FIG. 5 shows a configuration of a substrate processing apparatus 1b according to the third embodiment. The substrate processing apparatus 1b differs from the substrate processing apparatus 1a shown in FIG. 3 in that the third liquid supply part 33 is omitted and the first liquid supply part 31 is disposed below the substrate 9. In the substrate processing apparatus 1b shown in FIG. 5, a first liquid that is pre-cooled to a temperature lower than or equal to the freezing point of a second liquid is supplied from the first liquid supply part 31 to the center portion of the lower surface 92 of the substrate 9. The other constituent elements are the same as those of the substrate processing apparatus 1a shown in FIG. 3, and thus in the following description, corresponding constituent elements are all denoted by the same reference numerals. In the substrate processing apparatus 1b as well, hydrofluoric acid that is one of functional fluids having etching capability is used as the first liquid, and pure water, and more preferably deionized water, is used as the second liquid, similarly to the substrate processing apparatus 1a.

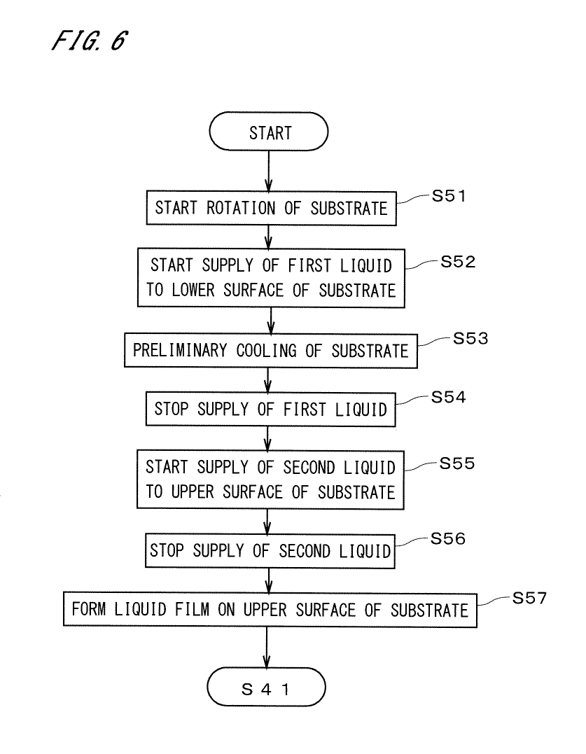

FIG. 6 is part of a flowchart of processing the substrate 9, performed by the substrate processing apparatus 1b. In the substrate processing apparatus 1b, similarly to the substrate processing apparatus 1a, first, the substrate 9 is transported into the chamber 7 and held by the substrate holding part 2, and the substrate rotating mechanism 5 starts rotating the substrate 9 under the control of the control part 8 (step S51). The number of revolutions of the substrate 9 is, for example, in the range of 300 to 900 rpm, and in the present embodiment, it is 400 rpm.

Then, the control part 8 controls the first liquid supply part 31 so that the supply of the first liquid from the first liquid supply part 31 to the lower surface 92 of the substrate 9 is started (step S52). The first liquid is pre-cooled to a temperature (e.g., in the range of −5 to 0° C.) lower than or equal to the freezing point of the second liquid. By the rotation of the substrate 9, the first liquid supplied to the lower surface 92 of the substrate 9 spreads from the center portion of the substrate 9 to the outer edge portion thereof and over the entire lower surface 92, and is scattered from the edge of the substrate 9 to the outside. The liquid scattered from the substrate 9 is received and collected by a cup part 21.

In the substrate processing apparatus 1b, the supply of the first liquid from the first liquid supply part 31 to the lower surface 92 of the substrate 9 is continued for a predetermined period of time while the substrate 9 is being rotated by the substrate rotating mechanism 5. As a result, the entire substrate 9 is preliminarily cooled to a temperature lower than or equal to 0° C. (i.e., the freezing point of the second liquid) (step S53). When the preliminary cooling of the substrate 9 has finished, the supply of the first liquid from the first liquid supply part 31 is stopped (step S54).

Next, the rotating speed of the substrate 9 by the substrate rotating mechanism 5 is decreased to the rotating speed lower than that when performing preliminary cooling. The number of revolutions of the substrate 9 is, for example, in the range of 50 to 300 rpm, and in the present embodiment, it is 80 rpm. Then, the control part 8 controls the second liquid supply part 32 so that the supply of the second liquid to the center portion of the upper surface 91 of the preliminarily cooled substrate 9 is started, the second liquid being pre-cooled to a temperature (e.g., 1° C.) lower than room temperature (step S55). By the rotation of the substrate 9, the second liquid supplied to the upper surface 91 of the substrate 9 spreads from the center portion of the substrate 9 to the outer edge portion thereof. After the elapse of a predetermined period of time, the supply of the second liquid is stopped (step S56).

In the substrate processing apparatus 1b, on the upper surface 91 of the substrate 9 being rotated at a low speed, part of the second liquid supplied to the upper surface 91 flows from the center portion of the substrate 9 to the edge thereof and is scattered from the substrate 9 to the outside. Then, a thin liquid film of the second liquid is formed on the upper surface 91 of the substrate 9 (step S57). The thickness of the liquid film is substantially uniform over the entire upper surface 91 of the substrate 9, and in the present embodiment, it is approximately 50 μm. Note that the thickness of the liquid film does not necessarily have to be uniform.

When the formation of the liquid film has finished, as in the substrate processing apparatus 1a shown in FIG. 3, the control part 8 controls the freezing part 4 so that cooling gas is supplied from the cooling gas nozzle 41 that repeats its reciprocal movements between the center portion of the substrate 9 and the edge thereof, to the upper surface 91 of the rotating substrate 9. As a result, the cooling gas is supplied over the entire upper surface 91 of the substrate 9, and the liquid film of the second liquid on the upper surface 91 is frozen into a frozen film (FIG. 4A, step S41).

When the formation of the frozen film has finished, the supply of the cooling gas from the freezing part 4 is stopped, and the rotating speed of the substrate 9 is increased to the rotating speed higher than that when forming the frozen film. Then, the control part 8 controls the heating liquid supply part 6 so that a heating liquid is supplied from the heating liquid supply part 6 to the upper surface 91 of the substrate 9. By the rotation of the substrate 9, the heating liquid spreads from the center portion of the substrate 9 to the outer edge portion thereof and over the entire upper surface 91. This causes the frozen film on the upper surface 91 to be rapidly thawed (i.e., liquefied) and scattered together with the heating liquid from the edge of the substrate 9 to the outside (step S42). Particles or the like adhering to the upper surface 91 of the substrate 9 are removed from the substrate 9, together with the liquid scattered from the substrate 9. The liquid scattered from the substrate 9 to the outside is received and collected by the cup part 21.

When the removal of the frozen film has finished, a rinsing liquid (e.g., deionized water having room temperature) is supplied to the upper surface 91 of the substrate 9, and processing for rinsing the substrate 9 is performed (step S43). Thereafter, the rotating speed of the substrate 9 is increased, and dry processing for removing the rinsing liquid on the substrate 9 is performed by the rotation of the substrate 9 (step S44). When the dry processing of the substrate 9 has finished, the rotation of the substrate 9 is stopped (step S45).

As described above, in the substrate processing apparatus 1b, after the substrate 9 is preliminarily cooled with the first liquid having a temperature lower than or equal to the freezing point of the second liquid, the liquid film of the second liquid is formed on the upper surface 91 of the substrate 9, and that liquid film is cooled with the cooling gas supplied from the freezing part 4 into a frozen film. This makes it possible, as in the substrate processing apparatus 1a shown in FIG. 3, to suppress an increase in the temperature of the liquid film due to the heat of the substrate 9 and to thereby shorten the time required to freeze the liquid film. Also, the cooling cost required to freeze the liquid film by the freezing part 4 can be reduced.

In the substrate processing apparatus 1b, the substrate 9 is preliminarily cooled to a temperature lower than or equal to the freezing point of the second liquid as in the substrate processing apparatus 1a shown in FIG. 3. Thus, the time required to freeze the liquid film can be even further shortened. Also, the cooling cost required to freeze the liquid film can be even further reduced. Furthermore, by pre-cooling the second liquid supplied from the second liquid supply part 32, it is possible to even further shorten the time required to freeze the liquid film and even further reduce the cooling cost required to freeze the liquid film.

As described above, in the substrate processing apparatus 1b, the first liquid is supplied to the lower surface 92 of the substrate 9 during the preliminary cooling of the substrate 9. This eliminates the need to perform the step of replacing the first liquid on the substrate 9 by the second liquid before the formation of the liquid film of the second liquid. As a result, the time required to perform the freeze cleaning processing of the substrate 9 can be shortened. Furthermore, using a functional fluid having etching capability as the first liquid enables more efficient removal of particles or the like on the lower surface 92 of the substrate 9.

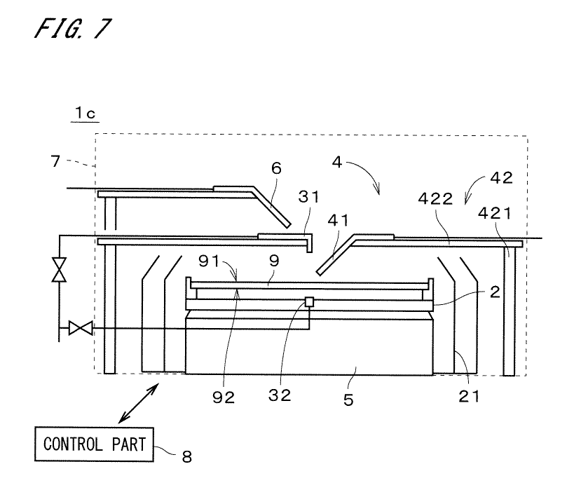

FIG. 7 shows a configuration of a substrate processing apparatus 1c according to a fourth embodiment of the present invention. As shown in FIG. 7, the substrate processing apparatus 1c is a single-wafer processing apparatus that processes semiconductor substrates 9 (hereinafter, simply referred to as “substrates 9”) one at a time. The substrate processing apparatus 1c performs freeze cleaning processing in which a frozen film is formed on a substrate 9 and then removed so as to remove particles or the like from the substrate 9.

The substrate processing apparatus 1c includes a substrate holding part 2, a cup part 21, a first liquid supply part 31, a second liquid supply part 32, a freezing part 4, a substrate rotating mechanism 5, a heating liquid supply part 6, a chamber 7, and a control part 8. The control part 8 controls constituent elements such as the first liquid supply part 31, the second liquid supply part 32, the freezing part 4, the substrate rotating mechanism 5, and the heating liquid supply part 6, for example. The substrate holding part 2 holds a substrate 9 with one major surface 91 (hereinafter, referred to as an “upper surface 91”) of the substrate 9 facing up in the chamber 7. A circuit pattern, for example, is formed on the upper surface 91 of the substrate 9. The cup part 21 surrounds the substrate 9 and the substrate holding part 2 in the chamber 7. The substrate rotating mechanism 5 rotates the substrate 9 together with the substrate holding part 2 in a horizontal plane about a rotation axis that passes through the center of the substrate 9 and is perpendicular to the upper surface 91 of the substrate 9.

The first liquid supply part 31 ejects a pre-cooled liquid toward a center portion of the upper surface 91 of the substrate 9. The second liquid supply part 32 also ejects the same liquid as that supplied from the first liquid supply part 31 toward a center portion of the other major surface 92 (hereinafter, referred to as a “lower surface 92”) of the substrate 9. In the present embodiment, pure water (preferably, deionized water (DIW)) that is cooled to approximately 0.5° C. is supplied from the first liquid supply part 31 and the second liquid supply part 32 to the upper surface 91 and the lower surface 92 of the substrate 9.

The freezing part 4 supplies cooling gas to the upper surface 91 of the substrate 9. The cooling gas is gas that is cooled to a temperature lower than 0° C., which is the freezing point of pure water supplied from the first liquid supply part 31. The freezing part 4 includes a cooling gas nozzle 41 that ejects the cooling gas, and a nozzle turning mechanism 42 for turning the cooling gas nozzle 41 horizontally about a rotation shaft 421. The nozzle turning mechanism 42 is provided with an arm 422 that extends in a horizontal direction from the rotation shaft 421 and to which the cooling gas nozzle 41 is attached. An example of the cooling gas being used is cooled nitrogen (N₂) gas. The temperature of the cooling gas is preferably in the range of −100 to −20° C., and in the present embodiment, it is approximately −50° C.

The heating liquid supply part 6 supplies a heating liquid, which is a liquid that has been heated, to the center portion of the upper surface 91 of the substrate 9. In FIG. 7, for the convenience of illustration, the heating liquid supply part 6 is illustrated above the first liquid supply part 31, but in actuality, the heating liquid supply part 6 is moved from the outside to above the substrate 9 in a state in which the first liquid supply part 31 has been retracted from above the substrate 9 toward the outside. When the first liquid supply part 31 is above the substrate 9, the heating liquid supply part 6 is retracted from above the substrate 9 toward the outside. An example of the heating liquid being used is pure water (preferably, deionized water) that is heated to a temperature higher than room temperature. The temperature of the heating liquid is preferably in the range of 50 to 90° C., and in the present embodiment, it is approximately 80° C.

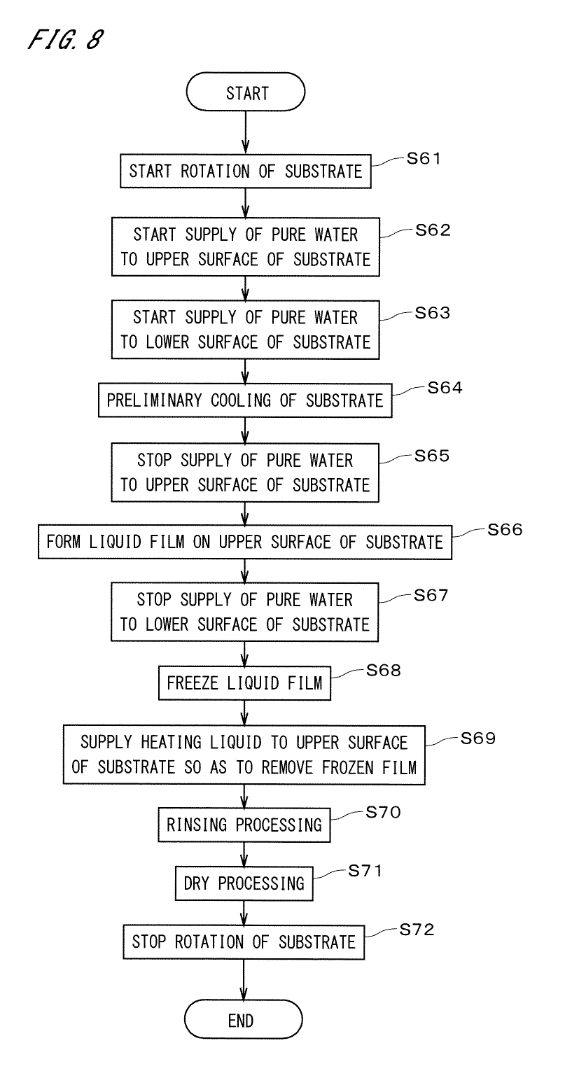

FIG. 8 is a flowchart of processing the substrate 9, performed by the substrate processing apparatus 1c. In the substrate processing apparatus 1c, first, the substrate 9 is transported into the chamber 7 and held by the substrate holding part 2, and the substrate rotating mechanism 5 starts rotating the substrate 9 under the control of the control part 8 (step S61). The number of revolutions of the substrate 9 is, for example, in the range of 300 to 900 rpm, and in the present embodiment, it is 400 rpm.

Then, the control part 8 controls the first liquid supply part 31 and the second liquid supply part 32 so that the supply of pure water from the first liquid supply part 31 to the upper surface 91 of the substrate 9 is started, and the supply of pure water from the second liquid supply part 32 to the lower surface 92 of the substrate 9 is started (steps S62 and S63). By the rotation of the substrate 9, the pure water supplied to the upper surface 91 and the lower surface 92 of the substrate 9 spreads from the center portion of the substrate 9 to the outer edge portion thereof and over the entire upper surface 91 and the entire lower surface 92, and is scattered from the edge of the substrate 9 to the outside. The pure water scattered from the substrate 9 is received and collected by the cup part 21.

In the substrate processing apparatus 1c, the supply of the pure water from the first liquid supply part 31 and the second liquid supply part 32 is continued for a predetermined period of time, and the substrate 9 is cooled to approximately the same temperature as that of the pure water supplied from the first liquid supply part 31 and the second liquid supply part 32 (step S64). In the following description, the cooling of the substrate 9 in step S64 is referred to as “preliminary cooling”. In the present embodiment, the entire substrate 9 is cooled to approximately 0.5° C. by the preliminary cooling.

Thereafter, the rotating speed of the substrate 9 by the substrate rotating mechanism 5 is decreased to the rotating speed lower than that when preliminarily cooling the substrate 9. The number of revolutions of the substrate 9 is, for example, in the range of 50 to 300 rpm, and in the present embodiment, it is 80 rpm. Then, the supply of the pure water from the first liquid supply part 31 to the upper surface 91 of the substrate 9 is stopped (step S65). In the substrate processing apparatus 1c, on the upper surface 91 of the substrate 9 being rotated at a low speed, part of the pure water remaining on the upper surface 91 flows from the center portion of the substrate 9 to the edge thereof and is scattered from the substrate 9 to the outside. Then, a thin liquid film of the pure water is formed on the upper surface 91 of the substrate 9 (step S66). The thickness of the liquid film is substantially uniform over the entire upper surface 91 of the substrate 9, and in the present embodiment, it is approximately 50 μm. Note that the thickness of the liquid film does not necessarily have to be uniform.

In the substrate processing apparatus 1c, even during the formation of the liquid film on the upper surface 91 of the substrate 9, the second liquid supply part 32 continuously supplies pure water to the lower surface 92 of the rotating substrate 9, so as to cool the lower surface 92 of the substrate 9. In other words, the second liquid supply part 32 serves as a cooling part that supplies a cooling liquid that has been cooled to the lower surface 92 of the substrate 9 on which the liquid film is being formed, so as to cool the substrate 9.

When the formation of the liquid film has finished, the supply of the pure water from the second liquid supply part 32 is stopped (step S67). Then, the nozzle turning mechanism 42 of the freezing part 4 starts turning the cooling gas nozzle 41 under the control of the control part 8, and the cooling gas nozzle 41 repeats its reciprocal movements between the center portion of the substrate 9 and the edge thereof. Then, cooling gas is supplied from a cooling gas supply source provided outside the substrate processing apparatus 1c to the cooling gas nozzle 41 and is then supplied from the cooling gas nozzle 41 to the upper surface 91 of the rotating substrate 9. As a result, the cooling gas is supplied over the entire upper surface 91 of the substrate 9, and the liquid film on the upper surface 91 is cooled and frozen (step S68). Hereinafter, the liquid film that has been frozen is also referred to as a “frozen film”. Note that in the substrate processing apparatus 1c, the frozen film may be formed by supplying cooling gas from the cooling gas nozzle 41 that has stopped above the center portion of the substrate 9 and causing the cooling gas to spread from the center portion of the substrate 9 to the outer edge portion thereof by the rotation of the substrate 9.

On the substrate 9, the pure water that has entered between the substrate 9 and particles or the like is frozen (solidifies) and increases in volume, thereby lifting the particles or the like off from the substrate 9 by a small distance. As a result, the adhesion strength between the particles or the like and the substrate 9 is reduced, and the particles or the like are detached from the substrate 9. The particles or the like adhering to the substrate 9 will also fall off from the substrate 9 as a result of the pure water increasing in volume in a direction parallel to the upper surface 91 of the substrate 9 when it is frozen.

When the formation of the frozen film has finished, the supply of the cooling gas from the freezing part 4 is stopped, and the cooling gas nozzle 41 is moved from above the substrate 9 toward the outside. Then, the rotating speed of the substrate 9 by the substrate rotating mechanism 5 is increased to the rotating speed higher than that when forming the frozen film. The number of revolutions of the substrate 9 is, for example, in the range of 1500 to 2500 rpm, and in the present embodiment, it is 2000 rpm.

Next, the heating liquid supply part 6 is controlled by the control part 8 so that a heating liquid is supplied from the heating liquid supply part 6 to the upper surface 91 of the substrate 9. By the rotation of the substrate 9, the heating liquid spreads from the center portion of the substrate 9 to the outer edge portion thereof and over the entire upper surface 91. This causes the frozen film on the upper surface 91 to be rapidly thawed (i.e., liquefied) and scattered together with the heating liquid from the edge of the substrate 9 to the outside (step S69). Particles or the like adhering to the upper surface 91 of the substrate 9 are removed from the substrate 9, together with the liquid scattered from the substrate 9. The liquid scattered from the substrate 9 to the outside is received and collected by the cup part 21. In the substrate processing apparatus 1c, the heating liquid supply part 6 serves as a frozen-film removing part that supplies a heating liquid serving as a thawing liquid to the frozen film on the substrate 9 so as to remove the frozen film.

When the removal of the frozen film has finished, a rinsing liquid (e.g., deionized water having room temperature) is supplied from a rinsing liquid supply part (not shown) to the upper surface 91 of the substrate 9, and processing for rinsing the substrate 9 is performed (step S70). The number of revolutions of the substrate 9 during the rinsing processing is preferably in the range of 300 to 1000 rpm, and in the present embodiment, it is 800 rpm. Thereafter, the number of revolutions of the substrate 9 is changed to the range of 1500 to 3000 rpm (in the present embodiment, 2000 rpm), and dry processing for removing the rinsing liquid on the substrate 9 is performed by the rotation of the substrate 9 (step S71). When the dry processing of the substrate 9 has finished, the rotation of the substrate 9 by the substrate rotating mechanism 5 is stopped (step S72).

As described above, in the substrate processing apparatus 1c, the lower surface 92 of the rotating substrate 9 is cooled by the second liquid supply part 32 during the formation of the liquid film on the upper surface 91 of the substrate 9. This suppresses an increase in the temperatures of the substrate 9 and the liquid film during the formation of the liquid film. As a result, the time required to freeze the liquid film when using the freezing part 4 can be shortened. Furthermore, even if the temperature of the cooling gas supplied from the freezing part 4 is increased, the liquid film can be speedily frozen. It is thus possible to simplify heat insulating facilities such as piping that supply the cooling gas from the cooling gas supply source to the cooling gas nozzle 41. As a result, the cooling cost required to freeze the liquid film using the freezing part 4 can be reduced.

In the substrate processing apparatus 1c, it is preferable that the supply of the pure water from the second liquid supply part 32 to the lower surface 92 of the substrate 9 be performed until immediately before the supply of the cooling gas from the freezing part 4 to the substrate 9 is started. This makes it possible to start the freezing of the liquid film in a state in which the temperatures of the substrate 9 and the liquid film are kept low.

Incidentally, in a substrate processing apparatus in which the lower surface of a substrate is not cooled at the time of forming a liquid film (hereinafter, referred to as a “substrate processing apparatus of a comparative example”), if the rotation time of the substrate required to form a liquid film, i.e., a liquid-film forming time, increases, the amount of heat that flows from gas or the like around the substrate into the substrate and the liquid film will increase, and accordingly, the temperatures of the substrate and the liquid film will rise.

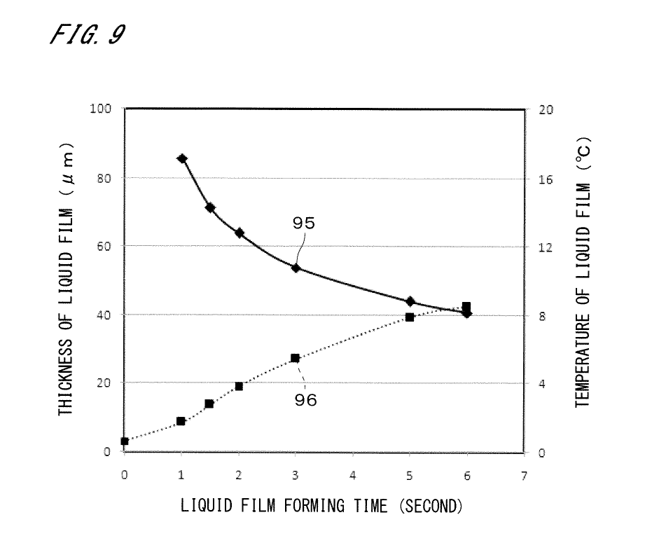

FIG. 9 shows the relationship between the liquid-film forming time and the thickness and temperature of the liquid film at a predetermined position on the substrate in the substrate processing apparatus of the comparative example. The horizontal axis in FIG. 9 indicates the liquid-film forming time, and the vertical axes on the left and right sides respectively indicate the thickness and temperature of the liquid film at a predetermined position on the substrate. A solid line 95 in FIG. 9 indicates the thickness of the liquid film, and a broken line 96 indicates the temperature of the liquid film.

As shown in FIG. 9, the thickness of the liquid film can be reduced by prolonging the liquid-film forming time, but this will increase the temperature of the liquid film, thus increasing the time required to freeze the liquid film and causing the need to considerably lower the temperature of the cooling gas supplied from the freezing part. For this reason, in the substrate processing apparatus of the comparative example, a sufficient liquid-film forming time cannot be secured, and thus it is difficult to reduce the thickness of the liquid film to the desired thickness. The thickness of the liquid film is correlated with the removal rate of particles or the like from the substrate, and if the thickness of the liquid film deviates sharply from the desired thickness, the removal rate of particles or the like will drop.

In contrast, in the substrate processing apparatus 1c according to the present embodiment, as described above, an increase in the temperatures of the substrate 9 and the liquid film can be suppressed by cooling the substrate 9 from the lower surface 92 during the formation of the liquid film. It is thus possible to secure a sufficient liquid-film forming time and thereby form a liquid film of the desired thickness. As a result, the removal rate of particles or the like from the substrate 9 can be improved.

In the substrate processing apparatus 1c, by supplying pure water serving as a cooling liquid from the second liquid supply part 32 to the lower surface 92 of the substrate 9, the cooling of the substrate 9 during the formation of the liquid film can be performed more efficiently than in the case where the substrate 9 is cooled by supplying cooling gas to the lower surface 92 of the substrate 9. Note that, when the liquid film is frozen, the pure water remaining on the lower surface 92 of the substrate 9 is also frozen together with the liquid film on the upper surface 91, but since the heat capacity of the substrate 9 is higher than that of the pure water on the upper surface 91 and the lower surface 92, the amount of heat required to freeze the pure water on the lower surface 92 is smaller than the amount of heat that becomes unnecessary as a result of the preliminary cooling which suppresses an increase in the temperature of the substrate 9. Accordingly, the amount of heat required to freeze the liquid film in the substrate processing apparatus 1c is smaller than that in the substrate processing apparatus of the comparative example.

In the substrate processing apparatus 1c, since the liquid supplied from the second liquid supply part 32 to the lower surface 92 is the same liquid as that supplied from the first liquid supply part 31 to the upper surface 91, it is possible to simplify the structure of the substrate processing apparatus 1c by, for example, sharing part of piping between the first liquid supply part 31 and the second liquid supply part 32 or sharing a common cooling mechanism in the piping. It is also possible to collect the liquids supplied to the upper surface 91 and the lower surface 92 of the substrate 9 and reuse the collected liquid for the processing of the substrate processing apparatus 1c.

Since, as described above, the frozen film on the substrate 9 is formed of pure water having a relatively high volume expansion coefficient, the adhesion strength of particles or the like to the substrate 9 can be even further reduced as compared with the case where the frozen film is formed of any other liquid. This results in an improvement in the removal rate of particles or the like from the substrate 9. Furthermore, by supplying a heating liquid so as to remove the frozen film, particles or the like adhering to the substrate 9 can be efficiently removed together with the frozen film. In the substrate processing apparatus 1c, by using the same liquid as that supplied from the first liquid supply part 31 and the second liquid supply part 32 as the heating liquid, it is also possible to collect and reuse the liquid scattered from the substrate 9 when the frozen film is thawed.

In the substrate processing apparatus 1c, a mechanism for supplying cooled gas (e.g., nitrogen gas) to the lower surface 92 of the substrate 9 may be provided, instead of the second liquid supply part 32, as a cooling part that cools the substrate 9 during the formation of a liquid film. Using gas to cool the substrate 9 in this way avoids the possibility that pure water from the lower surface 92 of the substrate 9 will enter the upper surface 91 and be frozen during the formation of the frozen film, during which the rotating speed of the substrate 9 is lower than that during the formation of the liquid film, thus improving uniformity in the thickness of the frozen film.

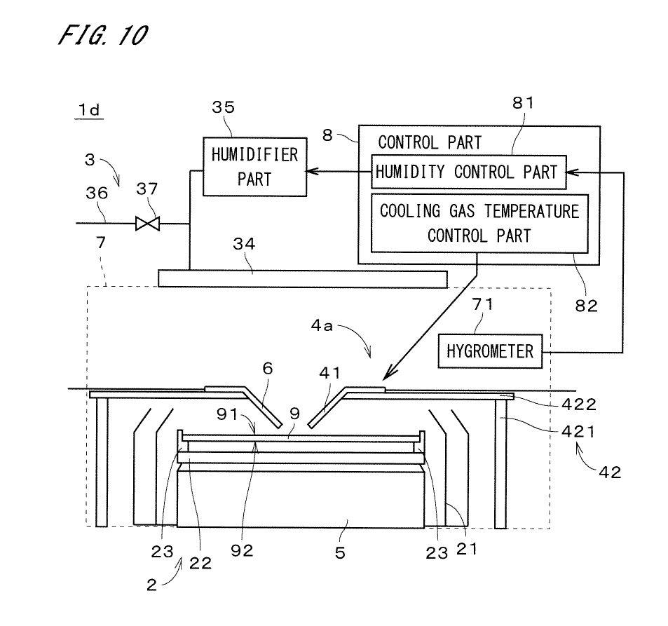

FIG. 10 shows a configuration of a substrate processing apparatus 1d according to a fifth embodiment of the present invention. As shown in FIG. 10, the substrate processing apparatus 1d is a single-wafer processing apparatus that processes semiconductor substrates 9 (hereinafter, simply referred to as “substrates 9”) one at a time. The substrate processing apparatus 1d performs freeze cleaning processing in which a frozen film is formed on a substrate 9 and then removed so as to remove particles or the like from the substrate 9.

The substrate processing apparatus 1d includes a substrate holding part 2, a cup part 21, a process gas supply part 3, a cooling medium supply part 4a, a substrate rotating mechanism 5, a heating liquid supply part 6, a chamber 7, a hygrometer 71, and a control part 8. The control part 8 includes a humidity control part 81 that controls the humidity in the chamber 7, and a cooling gas temperature control part 82 that controls the temperature of cooling gas, which will be described later. The control part 8 controls constituent elements such as the process gas supply part 3, the cooling medium supply part 4a, the substrate rotating mechanism 5, and the heating liquid supply part 6, for example.

The substrate holding part 2 holds a substrate 9 with one major surface 91 (hereinafter, referred to as an “upper surface 91”) of the substrate 9 facing up in the chamber 7. The substrate holding part 2 includes a holding body 22 having a substantially disc shape, and a plurality of support parts 23 that are provided on the holding body 22. The support parts 23 support a lower surface 92 that is the other major surface of the substrate 9. There is a gap between the lower surface 92 of the substrate 9 and the holding body 22. A circuit pattern, for example, is formed on the upper surface 91 of the substrate 9. The cup part 21 surrounds the substrate 9 and the substrate holding part 2 in the chamber 7. The substrate rotating mechanism 5 rotates the substrate 9 together with the substrate holding part 2 in a horizontal plane about a rotation axis that passes through the center of the substrate 9 and is perpendicular to the upper surface 91 of the substrate 9.

The process gas supply part 3 supplies clean gas having room temperature to the internal space of the chamber 7. The process gas supply part 3 includes gas piping 36 that connects the chamber 7 and a dry gas supply source (not shown) provided outside the substrate processing apparatus 1d, a flow regulating part 37 that regulates the flow rate of clean and non-humidified dry gas supplied from the dry gas supply source, and a humidifier part 35 that adds water vapor to the dry gas. In the following description, the gas supplied from the process gas supply part 3 into the chamber 7 is referred to as “process gas”. Examples of the dry gas being used include air and nitrogen (N₂) gas. The process gas is supplied through a supply port 34 at the top of the chamber 7 and flows to the bottom of the chamber 7, and is discharged from the vicinity of the bottom of the chamber 7 to the outside. In the substrate processing apparatus 1d, the humidity in the chamber 7 is measured by the hygrometer 71 and output to the humidity control part 81 of the control part 8. The humidity control part 81 controls the humidifier part 35 of the process gas supply part 3 so that the humidity measured by the hygrometer 71 reaches predetermined target humidity.

The cooling medium supply part 4a supplies cooling gas serving as a cooling medium to the upper surface 91 of the substrate 9. The cooling gas is gas that is cooled to a temperature lower than the freezing point of pure water (0° C.). The cooling medium supply part 4a includes a cooling gas nozzle 41 that ejects the cooling gas, and a nozzle moving mechanism 42 for turning the cooling gas nozzle 41 horizontally about a rotation shaft 421. The nozzle moving mechanism 42 is provided with an arm 422 that extends in the horizontal direction from the rotation shaft 421 and to which the cooling gas nozzle 41 is attached. An example of the cooling gas being used is cooled nitrogen gas. The temperature of the cooling gas supplied from the cooling medium supply part 4a is controlled by the cooling gas temperature control part 82, and in the present embodiment, it is controlled within the range of −100 to −5° C.

The heating liquid supply part 6 supplies a heating liquid, which is a liquid that has been heated, to a center portion of the upper surface 91 of the substrate 9. An example of the heating liquid being used is pure water (preferably, deionized water) that is heated to a temperature higher than room temperature. The temperature of the heating liquid is preferably in the range of 50 to 90° C., and in the present embodiment, it is approximately 80° C.

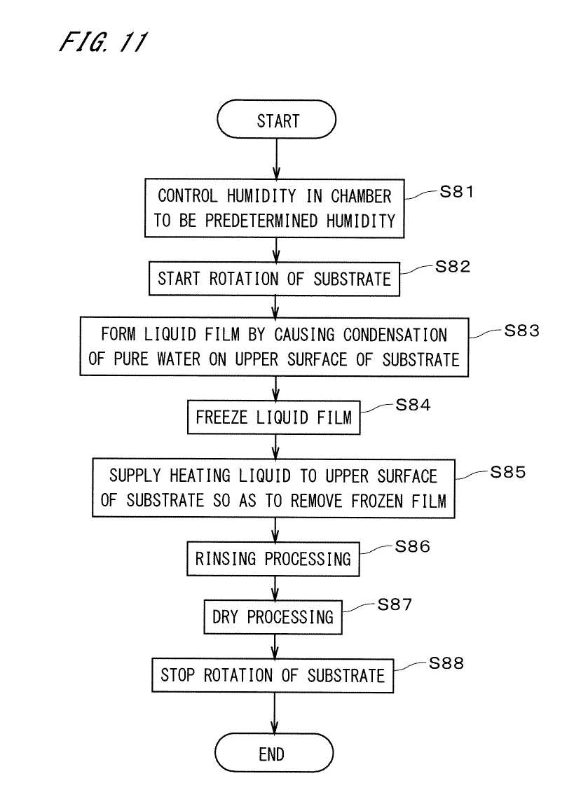

FIG. 11 is a flowchart of processing the substrate 9, performed by the substrate processing apparatus 1d. In the substrate processing apparatus 1d, first, the substrate 9 is transported into the chamber 7 and held by the substrate holding part 2. When a transport port of the chamber 7 is closed, the process gas supply part 3 is controlled by the humidity control part 81 of the control part 8 so that dry gas to which water vapor has not been added by the humidifier part 35 is supplied as process gas into the chamber 7 until the humidity in the chamber 7 reaches predetermined first humidity.

Then, water vapor is added to the dry gas by the humidifier part 35, and the humidity in the chamber 7 reaches predetermined second humidity higher than the first humidity (step S81). In the substrate processing apparatus 1d, the process gas supply part 3 is controlled by the humidity control part 81 so that the supply of the process gas is continued so as to keep the humidity in the chamber 7 at the second humidity. Next, the substrate rotating mechanism 5 starts rotating the substrate 9 under the control of the control part 8 (step S82). The number of revolutions of the substrate 9 is, for example, in the range of 10 to 500 rpm, and in the present embodiment, it is 50 rpm.

Thereafter, cooling gas is supplied from a cooling gas supply source provided outside the substrate processing apparatus 1d to the cooling gas nozzle 41 of the cooling medium supply part 4a and is then supplied from the cooling gas nozzle 41 to the center portion of the upper surface 91 of the rotating substrate 9. By the rotation of the substrate 9, the cooling gas spreads over the entire upper surface 91, and thereby the entire substrate 9 is cooled. As a result, condensation of moisture (pure water) contained in the process gas within the chamber 7 occurs on the upper surface 91 of the substrate 9, and a thin liquid film of pure water that covers the entire upper surface 91 is formed (step S83). In other words, the cooling medium supply part 4a serves as a substrate cooling part that cools the substrate 9 and also serves as a liquid-film forming part that forms a liquid film of pure water over the entire upper surface 91 of the substrate 9. Note that condensation also occurs on the lower surface 92 of the substrate 9.

When the formation of the liquid film has finished, the nozzle moving mechanism 42 of the cooling medium supply part 4a starts turning the cooling gas nozzle 41 under the control of the control part 8, and the cooling gas nozzle 41 repeats its reciprocal movements between the center portion of the substrate 9 and the outer edge portion thereof. As a result, the cooling gas is supplied to the entire upper surface 91 of the substrate 9, and the liquid film on the upper surface 91 is cooled and frozen (step S84). Hereinafter, the liquid film that has been frozen is also referred to as a “frozen film”. In the substrate processing apparatus 1d, the cooling medium supply part 4a also functions as the freezing part that cools and freezes the liquid film on the upper surface 91 of the substrate 9.

In this way, in the substrate processing apparatus 1d, when the liquid film is frozen, the cooling gas is supplied from the cooling gas nozzle 41 that is moved reciprocally by the nozzle moving mechanism 42 to the upper surface 91 of the substrate 9 while the substrate 9 is being rotated by the substrate rotating mechanism 5. This allows the upper surface 91 to face the cooling gas nozzle 41 at any position in the radial direction of the substrate 9, thus improving uniformity of cooling of the upper surface 91 of the substrate 9.

On the substrate 9, the pure water that has entered between the substrate 9 and particles or the like is frozen (solidifies) and increases in volume, thereby lifting the particles or the like off from the substrate 9 by a small distance. As a result, the adhesion strength between the particles or the like and the substrate 9 is reduced, and particles or the like are detached from the substrate 9. Particles or the like adhering to the substrate 9 also fall off from the substrate 9 as a result of the pure water increasing in volume in a direction parallel to the upper surface 91 of the substrate 9 when it is frozen.

In the cooling medium supply part 4a, the temperature of the cooling gas supplied from the cooling gas nozzle 41, which makes reciprocal movements between the center portion of the substrate 9 and the outer edge portion thereof, is controlled based on the position of the cooling gas nozzle 41. Specifically, the cooling gas temperature control part 82 controls the cooling medium supply part 4a so that the temperature of the cooling gas ejected from the cooling gas nozzle 41 at a position facing the outer edge portion of the substrate 9 becomes lower than the temperature of the cooling gas ejected from the cooling gas nozzle 41 at a position facing the center portion of the substrate 9. In other words, the temperature of the cooling gas that is supplied from the cooling gas nozzle 41 to the outer edge portion of the substrate 9 is lower than the temperature of the cooling gas that is supplied to the center portion of the substrate 9.

In the substrate processing apparatus 1d, the temperature of the outer edge portion of the substrate 9 is more likely to approach room temperature than the temperature of the center portion of the substrate 9 due to the process gas of room temperature that flows downward around the substrate 9. Thus, if, as described above, the temperature of the cooling gas supplied from the cooling gas nozzle 41 to the outer edge portion of the substrate 9 is set to be lower than the temperature of the cooling gas supplied to the center portion of the substrate 9, uniformity of cooling of the upper surface 91 of the substrate 9 can be further improved.

When the formation of the frozen film has finished, the supply of the cooling gas from the cooling medium supply part 4a is stopped, and the cooling gas nozzle 41 is moved from above the substrate 9 toward the outside. Then, the rotating speed of the substrate 9 by the substrate rotating mechanism 5 is increased to the rotating speed higher than that when forming the frozen film. The number of revolutions of the substrate 9 is, for example, in the range of 1500 to 2500 rpm, and in the present embodiment, it is 2000 rpm.

Then, the control part 8 controls the heating liquid supply part 6 so that a heating liquid is supplied from the heating liquid supply part 6 to the upper surface 91 of the substrate 9. By the rotation of the substrate 9, the heating liquid spreads from the center portion of the substrate 9 to the outer edge portion thereof and over the entire upper surface 91. This causes the frozen film on the upper surface 91 to be rapidly thawed (i.e., liquefied) and scattered together with the heating liquid from the edge of the substrate 9 to the outside (step S85). Particles or the like adhering to the upper surface 91 of the substrate 9 are removed from the substrate 9, together with the liquid scattered from the substrate 9. The liquid scattered from the substrate 9 to the outside is received and collected by the cup part 21. In the substrate processing apparatus 1d, the heating liquid supply part 6 serves as a frozen-film removing part that supplies the heating liquid serving as a thawing liquid to the frozen film on the substrate 9 so as to remove the frozen film.

When the removal of the frozen film has finished, a rinsing liquid (e.g., deionized water having room temperature) is supplied from a rinsing liquid supply part (not shown) to the upper surface 91 of the substrate 9, and processing for rinsing the substrate 9 is performed (step S86). The number of revolutions of the substrate 9 during the rinsing processing is preferably in the range of 300 to 1000 rpm, and in the present embodiment, it is 800 rpm. Thereafter, the number of revolutions of the substrate 9 is changed to the range of 1500 to 3000 rpm (in the present embodiment, 2000 rpm), and dry processing for removing the rinsing liquid on the substrate 9 is performed by the rotation of the substrate 9 (step S87). When the dry processing of the substrate 9 has finished, the rotation of the substrate 9 by the substrate rotating mechanism 5 is stopped (step S88).

As described above, in the substrate processing apparatus 1d, the liquid film is formed by the condensation of pure water on the upper surface 91 of the substrate 9. It is thus possible to omit the structure for ejecting and supplying a liquid for forming a liquid film to the upper surface 91 of the substrate 9. This results in downsizing of the substrate processing apparatus 1d. Furthermore, a thin liquid film can be more easily formed on the entire upper surface 91 of the substrate 9 than in the case where a liquid film is formed by spreading a liquid from the center portion of the substrate to the outer edge portion thereof with the rotation of the substrate. By reducing the thickness of the liquid film in this way, the time required to freeze the liquid film can be shortened. Moreover, even if the temperature of the cooling gas supplied from the cooling medium supply part 4a is increased, the liquid film can be speedily frozen. It is thus possible to simplify heat insulating facilities such as piping that supply the cooling gas from the cooling gas supply source to the cooling gas nozzle 41. As a result, the cooling cost required to freeze the liquid film using the cooling medium supply part 4a can be reduced.

In the substrate processing apparatus 1d, the liquid film is formed by cooling the substrate 9 using the cooling medium supply part 4a so as to cause condensation of pure water on the upper surface 91 of the substrate 9. As a result, a liquid film having a temperature lower than room temperature is formed on the upper surface 91 of the substrate 9, and the time required to freeze the liquid film can be further shortened. Also, the cooling cost required to freeze the liquid film can be further reduced.

As described above, the cooling medium supply part 4a serves as both the liquid-film forming part that forms a liquid film on the upper surface 91 of the substrate 9 and the freezing part that cools and freezes the liquid film. Thus, the structure of the substrate processing apparatus 1d can be simplified. Furthermore, when the liquid film is formed on the upper surface 91 of the substrate 9, the humidity in the chamber 7 is maintained at the predetermined second humidity by the humidity control part 81. This makes it possible to maintain the speed of condensation on the substrate 9 (i.e., the amount of pure water that is liquefied per unit time) constant and easily form a liquid film of the desired thickness.

In the substrate processing apparatus 1d, particles or the like adhering to the substrate 9 can be efficiently removed together with the frozen film by supplying the heating liquid from the heating liquid supply part 6 so as to remove the frozen film from the substrate 9. By using pure water that forms the frozen film as the heating liquid, it is also possible to collect and reuse the liquid scattered from the substrate 9 when the frozen film is thawed.

In the substrate processing apparatus 1d, in step S84, the frozen film may be formed such that the cooling gas nozzle 41 that is disposed above the center portion of the substrate 9 and fixed relative to that center portion supplies cooling gas to the center portion of the upper surface 91 of the substrate 9, and the cooling gas spreads from the center portion of the substrate 9 to the outer edge portion thereof by the rotation of the substrate 9.

In step S83, the cooling gas nozzle 41 may supply cooling gas to the upper surface 91 of the substrate 9 while moving reciprocally between the center portion and the outer edge portion of the rotating substrate 9. This can improve uniformity of cooling of the upper surface 91 of the substrate 9 even during the formation of the liquid film.

Note that in steps S83 and S84, it is sufficient that the movement of the cooling gas nozzle 41 by the nozzle moving mechanism 42 is performed relative to the substrate 9, and for example, the substrate 9 may be moved together with the substrate holding part 2 with the cooling gas nozzle 41 being fixed. In this case as well, the uniformity of cooling of the upper surface 91 of the substrate 9 can be improved.

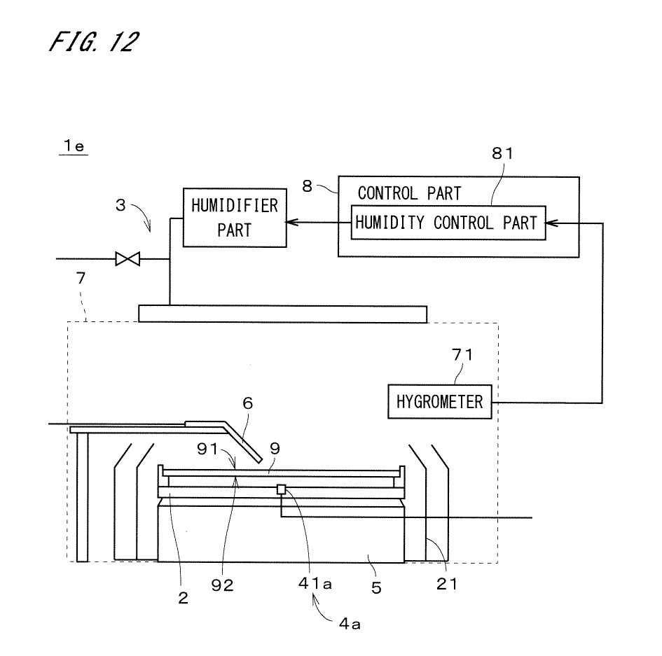

Next is a description of a substrate processing apparatus according to a sixth embodiment of the present invention. FIG. 12 shows a configuration of a substrate processing apparatus 1e according to the sixth embodiment. In the substrate processing apparatus 1e, a cooling medium supply part 4a is disposed below a substrate 9, and cooling gas serving as a cooling medium is supplied from a cooling gas nozzle 41a of the cooling medium supply part 4a to the center portion of a lower surface 92 of the substrate 9. The other constituent elements are the same as those of the substrate processing apparatus 1d shown in FIG. 10, and thus in the following description, corresponding constituent elements are denoted by the same reference numerals.

The flowchart of processing the substrate 9, performed by the substrate processing apparatus 1e is the same as that performed by the substrate processing apparatus 1d shown in FIG. 11, and therefore the following description will be given with reference to FIG. 11. In the substrate processing apparatus 1e, as in the substrate processing apparatus 1d, first, the substrate 9 is transported into the chamber 7 and held by the substrate holding part 2, and process gas is supplied by the process gas supply part 3 so that the humidity in the chamber 7 reaches first humidity. Then, the humidity control part 81 of the control part 8 controls the process gas supply part 3 based on the output from the hygrometer 71 so that the humidity in the chamber 7 reaches predetermined second humidity higher than the first humidity, and this second humidity is maintained (step S81). Also, the substrate rotating mechanism 5 starts rotating the substrate 9 (step S82). The number of revolutions of the substrate 9 is, for example, in the range of 10 to 500 rpm, and in the present embodiment, it is 50 rpm.

Next, cooling gas is supplied from the cooling medium supply part 4a serving as a substrate cooling part to the center portion of the lower surface 92 of the rotating substrate 9. The cooling gas spreads over the entire lower surface 92 by the rotation of the substrate 9, and the entire substrate 9 is cooled. As a result, condensation of moisture (pure water) contained in the process gas within the chamber 7 occurs on the upper surface 91 of the substrate 9, and a thin liquid film of pure water is formed on the upper surface 91 (step S83). Note that such condensation also occurs on the lower surface 92 of the substrate 9.

Even after the formation of the liquid film has finished, the supply of the cooling gas from the cooling medium supply part 4a is continued. The cooling gas is supplied to the entire lower surface 92 of the substrate 9 by the rotation of the substrate 9, and the liquid film on the upper surface 91 is cooled and frozen into a frozen film (step S84). When the formation of the frozen film has finished, the supply of the cooling gas from the cooling medium supply part 4a is stopped, and the rotating speed of the substrate 9 by the substrate rotating mechanism 5 is increased to the rotating speed higher than that when forming the frozen film. For example, the number of revolutions of the substrate 9 is in the range of 1500 to 2500 rpm, and in the present embodiment, it is 2000 rpm.

Then, a heating liquid is supplied from the heating liquid supply part 6 to the upper surface 91 of the substrate 9, and by the rotation of the substrate 9, the heating liquid spreads from the center portion of the substrate 9 to the outer edge portion thereof and over the entire upper surface 91. This causes the frozen film on the upper surface 91 to be quickly thawed (liquefied) and scattered together with the heating liquid from the edge of the substrate 9 to the outside (step S85). Particles or the like adhering to the upper surface 91 of the substrate 9 are removed from the substrate 9, together with the liquid scattered from the substrate 9. The liquid scattered from the substrate 9 to the outside is received and collected by the cup part 21.

When the removal of the frozen film has finished, a rinsing liquid (e.g., deionized water having room temperature) is supplied to the upper surface 91 of the substrate 9, and processing for rinsing the substrate 9 is performed (step S86). Thereafter, the rotating speed of the substrate 9 is increased, and dry processing for removing the rinsing liquid on the substrate 9 is performed by the rotation of the substrate 9 (step S87). When the dry processing of the substrate 9 has finished, the rotation of the substrate 9 is stopped (step S88).

As described above, in the substrate processing apparatus 1e, the liquid film is formed by the condensation of pure water on the upper surface 91 of the substrate 9 as in the substrate processing apparatus 1d shown in FIG. 10. It is thus possible to omit the structure for ejecting and supplying a liquid for forming a liquid film to the upper surface 91 of the substrate 9 and to thereby downsize the substrate processing apparatus 1e. Furthermore, since the thin liquid film can be easily formed on the substrate 9, the time required to freeze the liquid film can be shortened. Moreover, even if the temperature of the cooling gas supplied from the cooling medium supply part 4a is increased, the liquid film can be speedily frozen. Accordingly, it is possible to simplify heat insulating facilities such as piping that supply the cooling gas from the cooling gas supply source to the cooling gas nozzle 41a and to thereby reduce the cooling cost required to freeze the liquid film by the cooling medium supply part 4a.

With the substrate processing apparatus 1e, the liquid film having a temperature lower than room temperature can be formed by cooling the substrate 9 with the cooling medium supply part 4a so as to cause condensation of pure water on the upper surface 91 of the substrate 9. It is thus possible to further shorten the time required to freeze the liquid film and further reduce the cooling cost required to freeze the liquid film. Furthermore, since the cooling medium supply part 4a serves as both the liquid film forming part that forms a liquid film on the upper surface 91 of the substrate 9 and the freezing part that cools and freezes the liquid film, the structure of the substrate processing apparatus 1e can be simplified.

In the substrate processing apparatus 1e, in steps S83 and S84, the liquid film and the frozen film are formed without moving the cooling gas nozzle 41a of the cooling medium supply part 4a. Thus, the mechanism for moving the cooling gas nozzle 41a can be omitted, and accordingly the structure of the substrate processing apparatus 1e can be simplified.

Alternatively, the substrate processing apparatus 1e may be provided with a nozzle moving mechanism for reciprocally moving the cooling gas nozzle 41a between the center portion and the outer edge portion of the substrate 9 in order to improve uniformity of cooling of the upper surface 91 of the substrate 9 in steps S83 and S84. Note that it is sufficient that the cooling gas nozzle 41a is moved relative to the substrate 9 by the nozzle moving mechanism, and for example, the substrate 9 may be moved together with the substrate holding part 2 with the cooling gas nozzle 41a being fixed. In this case as well, uniformity of cooling of the upper surface 91 of the substrate 9 can be improved.

While the above has been a description of embodiments of the present invention, the present invention is not limited to the above-described embodiments and can be modified in various ways.

For example, in the substrate processing apparatus 1, the frozen film may be formed by supplying a supercooled liquid, obtained as a result of a liquid other than pure water (e.g., hydrogen water, carbonated water, SCl (ammonia-hydrogen peroxide mixture), or tert-Butanol (TBA)) being supercooled, from the first liquid supply part 31 to the upper surface 91 of the substrate 9 and freezing a liquid film of the supercooled liquid.

In the substrate processing apparatuses 1 and 1a to 1c, the freezing part 4 may freeze the liquid film by supplying cooling gas (e.g., oxygen, air, ozone, or argon) that is other than nitrogen and has a temperature lower than the freezing point of the liquid forming the liquid film, to the upper surface 91 of the substrate 9. Alternatively, the liquid film may be frozen by supplying cooling gas or a liquid that has a temperature lower than the freezing point of the liquid forming the liquid film, to the lower surface 92 of the substrate 9. Furthermore, in the heating liquid supply part 6, a variety of liquids other than pure water may be heated to a temperature higher than room temperature as a thawing liquid and supplied to the upper surface 91 of the substrate 9. As another alternative, a liquid having a temperature lower than or equal to room temperature may be used as a thawing liquid.

While in the first embodiment, the lower surface 92 of the substrate 9 is cooled by supplying a supercooled liquid, obtained as a result of pure water being supercooled, from the second liquid supply part 32 serving as a cooling part to the lower surface 92 before and during the formation of the liquid film on the upper surface 91 of the substrate 9, the cooling of the lower surface 92 may be performed by supplying a supercooled liquid obtained from a liquid other than pure water. Alternatively, the cooling of the lower surface 92 of the substrate 9 may be performed by supplying a liquid that is not supercooled and has a temperature lower than room temperature (more preferably, a liquid having a temperature lower than the freezing point of the liquid forming the liquid film on the upper surface 91 of the substrate 9) from the cooling part to the lower surface 92, or it may be performed by supplying gas having a temperature lower than room temperature.

In the substrate processing apparatus 1, as long as an increase in the temperature of the liquid film during the formation thereof is within an allowable range, the cooling of the lower surface 92 of the substrate 9 by the cooling part may be omitted. Also, as long as an increase in the temperature of the liquid film due to absorption of the heat of the substrate 9 is within an allowable range, the preliminary cooling of the substrate 9 in step S14 may be omitted. In this case, the liquid film may have a temperature higher than or equal to the freezing point when the freeze processing by the freezing part 4 is started, but it is possible to shorten the time required to freeze the liquid film and to reduce the cooling cost required to freeze the liquid film by the freezing part 4, as compared with the case where a liquid film is formed by supplying a liquid having a temperature higher than the freezing point to the upper surface 91 of the substrate 9.

For example, in the substrate processing apparatus 1a according to the second embodiment, the first liquid supplied from the first liquid supply part 31 to the upper surface 91 of the substrate 9 does not necessarily have to be a functional fluid having etching capability, and for example, it may be a liquid that does not have etching capability, such as isopropyl alcohol (IPA; the freezing point is −89.5° C.).

In the substrate processing apparatus 1a, after the supply of the first liquid and the third liquid is stopped in step S36 and before the supply of the second liquid is started in step S37, dry processing for removing the first liquid and the third liquid from the substrate 9 may be performed by the rotation of the substrate 9. In this case, the replacement of the first liquid by the second liquid in step S38 is not performed. Furthermore, in the substrate processing apparatus 1a, the third liquid supply part 33 may be omitted if there is no need to perform the processing for cleaning the lower surface 92 of the substrate 9.

In the substrate processing apparatus 1a and the substrate processing apparatus 1b, as long as a liquid having a temperature lower than or equal to the freezing point of the second liquid is supplied as the first liquid, the freezing point of the first liquid does not necessarily have to be lower than the freezing point of the second liquid. For example, the first liquid may be the same liquid as the second liquid that is cooled to a temperature lower than or equal to the freezing point (i.e., supercooled). In the case where the second liquid is pure water that has a temperature higher than 0° C. and lower than room temperature, the first liquid may be pure water that is supercooled to 0° C. or lower. The term “supercooling” as used herein refers to a state in which a substance is at or below the temperature of phase change, without the phase change taking place. By using a liquid having a freezing point lower than the freezing point of the second liquid as the first liquid, the temperature of the first liquid supplied from the first liquid supply part 31 can be easily reduced to a temperature lower than or equal to the freezing point of the second liquid.

In the substrate processing apparatus 1a, as long as a liquid having a temperature lower than or equal to the freezing point of the third liquid is supplied as the first liquid, the freezing point of the first liquid does not necessarily have to be lower than the freezing point of the third liquid, and a liquid obtained by supercooling the same liquid as the third liquid may be used as the first liquid. By using a liquid having a freezing point lower than the freezing point of the third liquid as the first liquid, the temperature of the first liquid supplied from the first liquid supply part 31 can be easily reduced to a temperature lower than or equal to the freezing point of the third liquid.

In the substrate processing apparatus 1a and the substrate processing apparatus 1b, it is preferable that the temperature of the entire substrate 9 (at least the temperature of the upper surface 91 of the substrate 9) is reduced to a temperature lower than or equal to the freezing point of the second liquid by the preliminary cooling performed by the first liquid supply part 31, but as long as the substrate 9 is preliminarily cooled with the first liquid having a temperature lower than or equal to the freezing point of the second liquid, the temperature of the preliminarily cooled substrate 9 may be higher than the freezing point of the second liquid. Also, the second liquid supplied from the second liquid supply part 32 does not necessarily have to be pre-cooled.

The liquid supplied from the second liquid supply part 32 of the substrate processing apparatus 1c to the lower surface 92 of the substrate 9 is not limited to pure water. For example, carbonated water, hydrogen water or the like that is cooled may be supplied from the second liquid supply part 32 to the lower surface 92 of the substrate 9. Alternatively, a liquid such as isopropyl alcohol or hydrofluoric acid that has a freezing point lower than that of pure water supplied from the first liquid supply part 31 may be cooled to a temperature lower than or equal to the freezing point of pure water and supplied to the lower surface 92 of the substrate 9. As another alternative, pure water that is supercooled to a temperature lower than or equal to its freezing point may be supplied to the lower surface 92 of the substrate 9. By supplying a liquid having a temperature lower than or equal to the freezing point of pure water supplied from the first liquid supply part 31, to the lower surface 92 of the substrate 9 in this way, an increase in the temperatures of the substrate 9 and the liquid film during the formation of the liquid film can be further suppressed.

In the substrate processing apparatus 1c, the liquid supplied from the first liquid supply part 31 to the upper surface 91 of the substrate 9 does not necessarily have to be pre-cooled pure water, and for example, pure water having room temperature may be supplied to the upper surface 91 of the substrate 9, and a liquid film may be formed of that pure water. In this case, cooling facilities, heat insulating facilities, and the like in the mechanism for supplying pure water to the first liquid supply part 31 can be omitted, and the structure of the substrate processing apparatus 1c can be simplified. Furthermore, a configuration is also possible in which a liquid other than pure water (e.g., carbonated water, hydrogen water, SCl (ammonia-hydrogen peroxide mixture), or tert-Butanol (TBA)) is supplied from the first liquid supply part 31, and a liquid film is formed of that liquid.

The substrate processing apparatus 1e according to the sixth embodiment may be provided with a cooling liquid nozzle that ejects a fluid cooling medium (i.e., cooling liquid) to the lower surface 92 of the substrate 9, instead of the cooling gas nozzle 41a of the cooling medium supply part 4a. In this case, the temperature of the cooling liquid supplied from the cooling medium supply part 4a is lower than 0° C., which is the freezing point of pure water. Preferably, the cooling liquid supplied from the cooling liquid nozzle is filled in and held between the lower surface 92 of the substrate 9 and the substrate holding part 2. This enables efficient cooling of the substrate 9.

In the substrate processing apparatuses 1d and 1e according to the fifth and sixth embodiments, the cooling medium supply part 4a serves as both the liquid film forming part that forms a liquid film on the upper surface 91 of the substrate 9 and the freezing part that cools and freezes that liquid film, but the liquid film forming part and the freezing part may be provided separately. For example, a substrate processing apparatus may be provided with both the cooling gas nozzle 41 of the substrate processing apparatus 1d and the cooling gas nozzle 41a of the substrate processing apparatus 1e, in which a liquid film is formed on the upper surface 91 of the substrate 9 by supplying cooling gas from the cooling gas nozzle 41a serving as a liquid film forming part to the lower surface 92 of the substrate 9, and the liquid film is frozen by supplying cooling gas from the cooling gas nozzle 41 serving as a freezing part to the upper surface 91 of the substrate 9.

In the substrate processing apparatuses 1d and 1e, the way of cooling the substrate 9 in steps S83 and S84 is not limited to the supply of a cooling medium, and a cooling mechanism may be provided in the holding body 22 of the substrate holding part 2 so that the substrate 9 can be cooled by the holding body 22 located close to the lower surface 92 of the substrate 9. Alternatively, the substrate 9 may be cooled by bringing the substrate holding part 2 into contact with the lower surface 92 of the substrate 9. In this case, the substrate holding part 2 serves as a substrate cooling part.

In the substrate processing apparatuses 1d and 1e, the way of forming a liquid film on the substrate 9 does not necessarily have to be the cooling of the substrate 9. For example, the formation of a liquid film on the upper surface 91 of the substrate 9 may be performed by the humidity control part 81 of the control part 8 controlling the process gas supply part 3 such that process gas in which water vapor is supersaturated (i.e., process gas in a state in which the partial pressure of water vapor is higher than the saturated vapor pressure) is supplied into the chamber 7 and water vapor is liquefied on the substrate 9 having room temperature. In this case, the process gas supply part 3 that supplies the supersaturated process gas serves as a liquid film forming part.

Examples of substrates being processed by the substrate processing apparatuses 1 and 1a to 1e include glass substrates for photomasks, glass substrates for liquid crystal display, glass substrates for plasma display, substrates for FED (field emission display), substrates for optical disks, substrates for magnetic disks, and substrates for magneto-optical disks.

The configurations of the above-described preferred embodiments and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention. This application claims priority benefit under 35 U.S.C. Section 119 of Japanese Patent Application No. 2011-287742 filed in the Japan Patent Office on Dec. 28, 2011, Japanese Patent Application No. 2011-287743 filed in the Japan Patent Office on Dec. 28, 2011, Japanese Patent Application No. 2011-287744 filed in the Japan Patent Office on Dec. 28, 2011, and Japanese Patent Application No. 2011-287745 filed in the Japan Patent Office on Dec. 28, 2011, the entire disclosures of which are incorporated herein by reference.

### REFERENCE SIGNS LIST

1, 1a to 1e Substrate processing apparatus
2 Substrate holding part
4 Freezing part
4a Cooling-medium supply part
5 Substrate rotating mechanism
6 Heating liquid supply part
7 Chamber
9 Substrate
31 First liquid supply part
32 Second liquid supply part
33 Third liquid supply part
41, 41a Cooling gas nozzle
42 Nozzle moving mechanism
81 Humidity control part
82 Cooling gas temperature control part
91 Upper surface
92 Lower surface
S11 to S22, S31 to S45, S51 to S57, S61 to S72, S81 to S88 Step

1. A substrate processing apparatus for processing a substrate, comprising:
a chamber;
a substrate holding part that holds a substrate with one major surface facing up in said chamber;
a liquid supply part that supplies a supercooled liquid to said one major surface of said substrate, said supercooled liquid being supercooled to a temperature lower than a freezing point of said supercooled liquid,
a substrate rotating mechanism that rotates said substrate that has been supplied with said supercooled liquid about an axis perpendicular to said one major surface, so as to form a liquid film on said one major surface; and
a freezing part that cools and freezes said liquid film.

2. The substrate processing apparatus according to claim 1, wherein the formation of said liquid film by said substrate rotating mechanism is performed after a temperature of said one major surface is reduced to a temperature lower than the freezing point of said supercooled liquid by supplying said supercooled liquid from said liquid supply part to said one major surface of said substrate.

3. The substrate processing apparatus according to claim 1, further comprising a cooling part that cools the other major surface of said substrate that is being rotated, when said liquid film is formed.

4. The substrate processing apparatus according to claim 3, wherein said cooling part supplies said supercooled liquid to said other major surface.

5. The substrate processing apparatus according to claim 1, wherein said supercooled liquid is pure water.

6. The substrate processing apparatus according to claim 1, further comprising a frozen-film removing part that supplies a heated thawing liquid to a frozen film so as to remove said frozen film, said frozen film being said liquid film that has been frozen.

7. A substrate processing apparatus for processing a substrate, comprising:
a chamber;
a substrate holding part that holds a substrate with one major surface facing up in said chamber;
a first liquid supply part that supplies a pre-cooled first liquid to said substrate so as to preliminarily cool said substrate;
a second liquid supply part that supplies a second liquid to said one major surface of said preliminarily cooled substrate, said second liquid having a freezing point higher than or equal to a temperature of said first liquid;
a substrate rotating mechanism that rotates said substrate that has been supplied with said second liquid about an axis perpendicular to said one major surface, so as to form a liquid film of said second liquid on said one major surface; and
a freezing part that cools and freezes said liquid film.

8. The substrate processing apparatus according to claim 7, wherein said second liquid supply part supplies said second liquid that has been pre-cooled to said substrate.

9. The substrate processing apparatus according to claim 7, wherein the preliminary cooling by said first liquid supply part reduces a temperature of said substrate to a temperature lower than or equal to the freezing point of said second liquid.

10. The substrate processing apparatus according to claim 7, further comprising:
a third liquid supply part that supplies a third liquid to the other major surface of said substrate, said third liquid having a freezing point higher than or equal to the temperature of said first liquid,
wherein, with said substrate being rotated by said substrate rotating mechanism, said first liquid that is cooled to a temperature lower than or equal to the freezing point of said third liquid is supplied from said first liquid supply part to said one major surface of said substrate, and said third liquid is supplied from said third liquid supply part to said other major surface of said substrate.

11. The substrate processing apparatus according to claim 7, wherein said first liquid supply part supplies said first liquid to the other major surface of said substrate.

12. The substrate processing apparatus according to claim 7 wherein said second liquid is pure water.

13. The substrate processing apparatus according to claim 7, wherein said first liquid is a functional fluid having etching capability.

14. The substrate processing apparatus according to claim 7, further comprising a frozen-film removing part that supplies a heated thawing liquid to a frozen film so as to remove said frozen film, said frozen film being said liquid film that has been frozen.

15. A substrate processing apparatus for processing a substrate, comprising:
a chamber;
a substrate holding part that holds a substrate with one major surface facing up in said chamber;
a liquid supply part that supplies a liquid to said one major surface of said substrate;
a substrate rotating mechanism that rotates said substrate that has been supplied with said liquid about an axis perpendicular to said one major surface, so as to form a liquid film of said liquid on said one major surface;
a cooling part that cools the other major surface of said substrate that is being rotated, when said liquid film is formed; and
a freezing part that cools and freezes said liquid film.

16. The substrate processing apparatus according to claim 15, wherein said cooling part supplies a cooled cooling liquid to said other major surface of said substrate.

17. The substrate processing apparatus according to claim 16, wherein said cooling liquid is the same liquid as said liquid supplied from said liquid supply part.

18. The substrate processing apparatus according to claim 15, wherein said cooling part supplies cooled gas to said other major surface of said substrate.

19. The substrate processing apparatus according to claim 15, wherein said liquid supplied from said liquid supply part is pure water.

20. The substrate processing apparatus according to claim 15, further comprising a frozen-film removing part that supplies a heated thawing liquid to a frozen film so as to remove said frozen film, said frozen film being said liquid film that has been frozen.

21. A substrate processing apparatus for processing a substrate, comprising:
a chamber;
a substrate holding part that holds a substrate in said chamber;
a liquid film forming part that forms a liquid film on one major surface of said substrate by causing condensation of pure water on said one major surface; and
a freezing part that cools and freezes said liquid film.

22. The substrate processing apparatus according to claim 21, wherein said liquid film forming part serves as a substrate cooling part that cools said substrate.

23. The substrate processing apparatus according to claim 22, wherein said substrate cooling part also serves as said freezing part.

24. The substrate processing apparatus according to claim 22, wherein said substrate cooling part supplies cooling gas to the other major surface of said substrate.

25. The substrate processing apparatus according to claim 22, further comprising:
a substrate rotating mechanism that rotates said substrate about an axis perpendicular to said one major surface,
wherein, with said substrate being rotated by said substrate rotating mechanism, cooling gas is supplied from said substrate cooling part to a center portion of said one major surface of said substrate or a center portion of the other major surface of said substrate.

26. The substrate processing apparatus according to claim 22, further comprising:
a substrate rotating mechanism that rotates said substrate about an axis perpendicular to said one major surface,
wherein said substrate cooling part includes:
a cooling gas nozzle that supplies cooling gas to said substrate; and
a nozzle moving mechanism that reciprocally moves said cooling gas nozzle relative to said substrate between a center portion and an outer edge portion of said substrate, and
with said substrate being rotated by said substrate rotating mechanism, cooling gas is supplied from said cooling gas nozzle that is reciprocally moved by said nozzle moving mechanism to said one major surface or the other major surface of said substrate.

27. The substrate processing apparatus according to claim 26, further comprising:
a cooling gas temperature control part that controls a temperature of the cooling gas supplied from said substrate cooling part to said substrate,
wherein a temperature of the cooling gas that is supplied from said cooling gas nozzle to said outer edge portion of said substrate is lower than a temperature of the cooling gas that is supplied from said cooling gas nozzle to said center portion of said substrate.

28. The substrate processing apparatus according to claim 21, further comprising a humidity control part that controls humidity in said chamber.

29. The substrate processing apparatus according to claim 21, further comprising a frozen-film removing part that supplies a heated thawing liquid to a frozen film so as to remove said frozen film, said frozen film being said liquid film that has been frozen.

30. A substrate processing method of processing a substrate, comprising the steps of:
a) supplying a supercooled liquid to one major surface of a substrate that is held with said one major surface facing up in a chamber, said supercooled liquid being supercooled to a temperature lower than a freezing point of said supercooled liquid;
b) forming a liquid film on said one major surface by rotating said substrate about an axis perpendicular to said one major surface; and
c) cooling and freezing said liquid film.

31. A substrate processing method of processing a substrate, comprising the steps of:
a) supplying a pre-cooled first liquid to a substrate that is held with one major surface facing up in a chamber, so as to preliminarily cool said substrate;
b) supplying a second liquid to said one major surface of said substrate and rotating said substrate about an axis perpendicular to said one major surface so as to foam a liquid film of said second liquid on said one major surface, said second liquid having a freezing point higher than or equal to a temperature of said first liquid; and
c) cooling and freezing said liquid film.

32. A substrate processing method of processing a substrate, comprising the steps of:
a) supplying a liquid to one major surface of a substrate that is held with said one major surface facing up in a chamber;
b) forming a liquid film of said liquid on said one major surface by rotating said substrate about an axis perpendicular to said one major surface while cooling the other major surface of said substrate; and
c) cooling and freezing said liquid film.

33. A substrate processing method of processing a substrate, comprising the steps of:
a) forming a liquid film on one major surface of a substrate by causing condensation of pure water on said one major surface in a chamber; and
b) cooling and freezing said liquid film.
